(19) United States
(12) Patent Application Publication
(10) Pub. No.: US 2025/0048065 A1
(43) Pub. Date: Feb. 6, 2025

(54) IN-VEHICLE DEVICE, ROADSIDE DEVICE, CONTROL METHOD, AND COMPUTER PROGRAM

(71) Applicants: Sumitomo Electric Industries, Ltd., Osaka-shi, Osaka (JP); AutoNetworks Technologies, Ltd., Yokkaichi-shi, Mie (JP); Sumitomo Wiring Systems, Ltd., Yokkaichi-shi, Mie (JP)

(72) Inventor: Akihiro OGAWA, Osaka-shi, Osaka (JP)

(73) Assignees: Sumitomo Electric Industries, Ltd., Osaka-shi, Osaka (JP); AutoNetworks Technologies, Ltd., Yokkaichi-shi, Mie (JP); Sumitomo Wiring Systems, Ltd., Yokkaichi-shi, Mie (JP)

(21) Appl. No.: 18/717,438

(22) PCT Filed: Nov. 9, 2022
(86) PCT No.: PCT/JP2022/041653

§ 371 Date: Jun. 7, 2024

(30) Foreign Application Priority Data
Dec. 10, 2021 (JP) 2021-200942

(51) Int. Cl. H04W 4/44; G08G 1/0962; H04B 17/391; H04W 28/02

(52) U.S. Cl. CPC H04W 4/44; G08G 1/0962; H04B 17/3912; H04W 28/0215

(57) ABSTRACT

An in-vehicle device is installed in a vehicle, and includes: a communication unit configured to receive reception target data from a roadside device that is a device located outside the vehicle; and a learning unit configured to learn a reception condition for the reception target data by evaluating an extent to which the reception target data received by the communication unit has been used by a function control device installed in the vehicle. The learning unit specifies the reception condition, during a learning period in which the communication unit repeatedly receives the reception target data. The communication unit receives the reception target data according to whether or not the reception condition is satisfied, after the reception condition has been specified by the learning unit.

### TECHNICAL FIELD

The present disclosure relates to an in-vehicle device, a roadside device, a control method, and a computer program. This application claims priority on Japanese Patent Application No. 2021-200942 filed on Dec. 10, 2021, the entire content of which is incorporated herein by reference.

### BACKGROUND ART

A coordination system between an in-vehicle device installed in an automobile, a motorcycle, etc. (hereinafter referred to as a vehicle) and an external device such as a server computer (hereinafter simply referred to as a server) has been proposed. For example, data is uploaded from the in-vehicle device to the external device via wireless communication, and the external device uses the received data in various services that the external device provides. As a service provided by the external device, there is a service that provides information for supporting the driver of the vehicle.

Vehicles in recent years have been equipped with various electronic devices, and ECUs (Electric Control Units) for controlling the electronic devices. For example, a vehicle capable of automated driving is equipped with an automated drive ECU. The automated drive ECU communicates with the outside as appropriate, acquires necessary information (e.g., road traffic information and dynamic driving support information), and controls traveling of the own vehicle by using the acquired information. Examples of other ECUs include an engine control ECU, a stop-start control ECU, a transmission control ECU, an airbag control ECU, a power steering control ECU, and a hybrid control ECU. For the vehicle capable of automated driving, the external device provides services such as remote monitoring and remote control.

PATENT LITERATURE 1 below discloses a vehicle-side device for generating map data to be used for automated driving of a vehicle, and the vehicle-side device can reduce the amount of communication data between the vehicle and a server. When uploading probe data to the server that manages the map data, the vehicle-side device changes the upload frequency to a low frequency mode, based on a traveling area of the own vehicle, a weather condition, a time period, and a server instruction. The traveling area of the own vehicle refers to whether or not the vehicle is traveling in a low frequency area in which the upload frequency is set lower than usual. The weather condition refers to whether it is bad weather such as heavy rain, heavy snow, or dense fog. The time period refers to whether it is night or not. The server instruction refers to the server specifying a vehicle in charge of transmission.

### CITATION LIST

### Patent Literature

PATENT LITERATURE 1: WO2020/045318

### SUMMARY OF THE INVENTION

An in-vehicle device according to an aspect of the present disclosure is an in-vehicle device installed in a vehicle, and includes: a communication unit configured to receive reception target data from a roadside device that is a device located outside the vehicle; and a learning unit configured to learn a reception condition for the reception target data by evaluating an extent to which the reception target data received by the communication unit has been used by a function control device installed in the vehicle. The learning unit specifies the reception condition, during a learning period in which the communication unit repeatedly receives the reception target data. The communication unit receives the reception target data according to whether or not the reception condition is satisfied, after the reception condition has been specified by the learning unit.

### BRIEF DESCRIPTION OF DRAWINGS

FIG. 1 is a schematic diagram showing a configuration of a coordination system using an in-vehicle device and a server.

FIG. 2 is a block diagram showing a hardware configuration of the in-vehicle device shown in FIG. 1.

FIG. 3 is a block diagram showing a hardware configuration of a vehicle inside-outside coordination unit shown in FIG. 2.

FIG. 4 is a block diagram showing a hardware configuration of a server shown in FIG. 1.

FIG. 5 is a block diagram schematically showing hierarchical structures of software in a vehicle (specifically, in-vehicle device) and the server.

FIG. 6 is a block diagram showing a functional configuration of the vehicle inside-outside coordination unit related to download.

FIG. 7 is a flowchart showing a process related to download, executed by the vehicle inside-outside coordination unit.

FIG. 8 is a flowchart showing a learning process related to download, executed by the vehicle inside-outside coordination unit.

FIG. 9 is a block diagram showing functional configurations of the vehicle inside-outside coordination unit and the server related to upload.

FIG. 10 is a flowchart showing a process related to upload, executed by the vehicle inside-outside coordination unit.

FIG. 11 is a flowchart showing a learning process related to upload, executed by the vehicle inside-outside coordination unit.

FIG. 12 is a flowchart showing a process executed by the server.

FIG. 13 is a block diagram showing functional configurations of a vehicle inside-outside coordination unit and a server according to a modification.

### DETAILED DESCRIPTION

### Problems to be Solved by the Present Disclosure

In the aforementioned service (hereinafter also referred to as a connected service) provided by the coordination system, transmission and reception of data between the in-vehicle device and the roadside device (e.g., the server) are indispensable. However, if data is repeatedly transmitted and received between the in-vehicle device and the server, the amount of communication data and the wireless line usage fee increase in proportion to traveling hours of the vehicle, which may result in tightening of the resources of the wireless communication network. Here, the term “repeatedly” includes “regularly” (e.g., periodically) and “irregularly”. Meanwhile, if the communication frequency between the in-vehicle device and the server is simply reduced, the quality of the connected service is degraded.

The above problems cannot be solved by PATENT LITERATURE 1. That is, the technology disclosed in PATENT LITERATURE 1 can reduce the frequency of upload from the in-vehicle device to the server, but cannot reduce the amount of data that the in-vehicle device downloads from the server. In addition, it is necessary to clearly define predetermined conditions for reducing the upload frequency (i.e., low frequency area, weather condition, time period, etc.) through measurement or the like, and set the conditions in the in-vehicle device in advance, which is complicated.

Therefore, it is an object of the present disclosure to provide an in-vehicle device, a roadside device, a control method, and a computer program which are capable of appropriately reducing the communication frequency between an in-vehicle device and a roadside device without degrading the quality of a connected service.

### Effects of the Present Disclosure

According to the present disclosure, it is possible to provide an in-vehicle device, a roadside device, a control method, and a computer program which are capable of appropriately reducing the communication frequency between an in-vehicle device and a roadside device without degrading the quality of a connected service.

### Description of Embodiment of the Present Disclosure

Contents of the embodiment of the present disclosure are listed and described.

At least some parts of the embodiment described below may be combined together as desired.

(1) An in-vehicle device according to a first aspect of the present disclosure is an in-vehicle device installed in a vehicle, and includes: a communication unit configured to receive reception target data from a roadside device that is a device located outside the vehicle; and a learning unit configured to learn a reception condition for the reception target data by evaluating an extent to which the reception target data received by the communication unit has been used by a function control device installed in the vehicle. The learning unit specifies the reception condition, during a learning period in which the communication unit repeatedly receives the reception target data. The communication unit receives the reception target data according to whether or not the reception condition is satisfied, after the reception condition has been specified by the learning unit. Thus, the frequency with which the in-vehicle device downloads data of a service provided from the roadside device can be appropriately reduced without degrading the quality of the connected service, whereby useless download can be inhibited.

(2) In the above (1), the learning unit may include: an acquisition unit configured to acquire output data of the function control device, and traveling state data indicating a traveling state of the vehicle; a surrounding situation detection unit configured to generate surrounding situation data indicating a surrounding situation of the vehicle; an evaluation unit configured to generate a first evaluation index that evaluates traveling of the vehicle from the output data; and a determination unit configured to determine whether or not the reception target data has been effectively used by the function control device, by comparing the first evaluation index obtained when the reception target data has been received with the first evaluation index obtained when the reception target data has not been received, during the learning period. Upon determining that the reception target data has been effectively used, the determination unit may specify, as the reception condition, the traveling state data and the surrounding situation data obtained when the reception target data has been received. Thus, the condition for effective use of the downloaded data can be specified, whereby useless download, in which data not to be effectively used is downloaded, can be effectively inhibited.

(3) In the above (2), the first evaluation index may include at least one of comfort, traffic efficiency, and safety related to traveling of the vehicle. Thus, it is possible to appropriately determine whether or not the downloaded data has been effectively used.

(4) In the above (2) or (3), the determination unit may determine whether or not the reception target data has been effectively used by the function control device, by determining whether or not a difference of the first evaluation index obtained when the reception target data has been received, with respect to the first evaluation index obtained when the reception target data has not been received, during the learning period, is larger than or equal to a predetermined value that is larger than 0. After the reception condition has been specified by the learning unit, if the difference becomes smaller than the predetermined value, the learning unit may cause the communication unit to repeatedly receive the reception target data, and again execute a process of specifying the reception condition. Thus, when the learning result has become no longer effective, relearning is quickly executed to determine an appropriate reception condition again.

(5) In any one of the above (1) to (4), with the function control device having been updated, the learning unit may cause the communication unit to repeatedly receive the reception target data, and again execute the process of specifying the reception condition. Thus, an appropriate reception condition can be quickly determined again.

(6) In any one of the above (1) to (5), the communication unit may further transmit transmission target data to the roadside device, and receive, from the roadside device, a second evaluation index that evaluates a service provided by the roadside device. The learning unit may further learn a transmission condition for the transmission target data according to the second evaluation index, and specify the transmission condition, during a period in which the communication unit repeatedly transmits the transmission target data. After the transmission condition has been specified by the learning unit, the communication unit may transmit the transmission target data depending on whether or not the transmission condition is satisfied. Thus, the frequency with which the in-vehicle device uploads data to the roadside device can be appropriately reduced without degrading the quality of the connected service, whereby useless upload can be inhibited.

(7) An in-vehicle device according to a second aspect of the present disclosure is an in-vehicle device installed in a vehicle, and includes: a communication unit configured to receive reception target data from a roadside device that is a device located outside the vehicle; and a learning unit configured to learn propriety of reception of the reception target data by the communication unit. The learning unit includes: an acquisition unit configured to acquire output data of a function control device installed in the vehicle, and traveling state data indicating a traveling state of the vehicle; a surrounding situation detection unit configured to generate surrounding situation data indicating a surrounding situation of the vehicle; an evaluation unit configured to generate an evaluation index that evaluates traveling of the vehicle from the output data, during a predetermined period in which the communication unit repeatedly receives the reception target data; a determination unit configured to determine whether or not the reception target data has been effectively used by the function control device, by comparing the evaluation index obtained when the reception target data has been received with the evaluation index obtained when the reception target data has not been received, during the predetermined period; and a model configured to output data indicating the propriety of reception according to input data including the traveling state data and the surrounding situation data. The learning unit causes the model to perform machine learning by using learning data. The communication unit receives the reception target data according to output data of the model after learning. The learning data includes, as the input data, the traveling state data and the surrounding situation data that have been collected during the predetermined period, and includes, as the output data of the model, results of determination by the determination unit that have been collected during the predetermined period. Thus, the frequency with which the in-vehicle device downloads the data of the service provided from the roadside device can be appropriately reduced without degrading the quality of the connected service, whereby useless download can be inhibited.

(8) An in-vehicle device according to a third aspect of the present disclosure is an in-vehicle device installed in a vehicle, and includes: a communication unit configured to transmit transmission target data to a roadside device that is a device located outside the vehicle, and receive, from the roadside device, an evaluation index that evaluates a service provided by the roadside device; and a learning unit configured to learn a transmission condition for the transmission target data by using the evaluation index. The learning unit specifies the transmission condition, during a learning period in which the communication unit repeatedly transmits the transmission target data. The communication unit transmits the transmission target data according to whether or not the transmission condition is satisfied, after the transmission condition has been specified by the learning unit. Thus, the frequency with which the in-vehicle device uploads data to the roadside device can be appropriately reduced without degrading the quality of the connected service, whereby useless upload can be inhibited.

(9) In the above (8), the communication unit may further transmit, to the roadside device, traveling state data indicating a traveling state of the vehicle. The evaluation index may be generated by the roadside device, with the traveling state data and a surrounding situation of the vehicle being considered. The learning unit includes: a surrounding situation detection unit configured to generate surrounding situation data indicating the surrounding situation; and a determination unit configured to determine whether or not the transmission target data has been effectively used by the roadside device, by comparing the evaluation index obtained when the transmission target data has been transmitted with the evaluation index obtained when the transmission target data has not been transmitted, during the learning period. Upon determining that the transmission target data has been effectively used, the determination unit may specify, as the transmission condition, the traveling state data and the surrounding situation data obtained when the transmission target data has been transmitted. Thus, the roadside device can appropriately generate the evaluation index, and the in-vehicle device can appropriately determine the transmission condition for uploading the data to the roadside device.

(10) In the above (9), the determination unit may determine whether or not the transmission target data has been effectively used by the roadside device, by determining whether or not a difference of the evaluation index obtained when the transmission target data has been transmitted with respect to the evaluation index obtained when the transmission target data has not been transmitted, during the learning period, is larger than or equal to a predetermined value larger than 0. After the transmission condition has been specified by the learning unit, if the difference becomes smaller than the predetermined value, the learning unit may cause the communication unit to repeatedly transmit the transmission target data, and again execute a process of specifying the transmission condition. Thus, when the learning result has become no longer effective, relearning is quickly executed to determine an appropriate transmission condition again.

(11) An in-vehicle device according to a fourth aspect of the present disclosure is an in-vehicle device installed in a vehicle, and includes: a communication unit configured to transmit transmission target data to a roadside device that is a device located outside the vehicle, and receive, from the roadside device, an evaluation index that evaluates a service provided by the roadside device: and a learning unit configured to learn propriety of transmission of the transmission target data by the communication unit. The communication unit further transmits, to the roadside device, traveling state data indicating a traveling state of the vehicle. The evaluation index is generated by the roadside device with the traveling state data and a surrounding situation of the vehicle being considered. The learning unit includes: a surrounding situation detection unit configured to generate surrounding situation data indicating the surrounding situation; a determination unit configured to determine whether or not the transmission target data has been effectively used by the roadside device, by comparing the evaluation index obtained when the transmission target data has been transmitted with the evaluation index obtained when the transmission target data has not been transmitted, during a predetermined period in which the communication unit repeatedly transmits the transmission target data; and a model configured to output data indicating the propriety of transmission according to input data including the traveling state data and the surrounding situation data. The learning unit causes the model to perform machine learning by using learning data. The communication unit transmits the transmission target data according to output data of the model after learning. The learning data includes, as the input data, the traveling state data and the surrounding situation data that have been collected during the predetermined period, and includes, as the output data of the model, results of determination by the determination unit that have been collected during the predetermined period. Thus, the frequency with which the in-vehicle device uploads data to the roadside device can be appropriately reduced without degrading the quality of the connected service, whereby useless upload can be inhibited.

(12) A roadside device according to a fifth aspect of the present disclosure is a roadside device that communicates with any one of the in-vehicle devices according to the above (8) to (11), and includes: a service execution unit configured to execute a predetermined service; an evaluation unit configured to generate an evaluation index indicating an extent to which the transmission target data has been used by the service execution unit, and a communication unit configured to transmit the evaluation index to the in-vehicle device. Thus, the in-vehicle device can appropriately determine the transmission condition for uploading the data to the roadside device, and the frequency with which the in-vehicle device uploads the data to the roadside device can be appropriately reduced, whereby useless upload can be inhibited.

(13) A roadside device according to a sixth aspect of the present disclosure includes: a communication unit configured to communicate with an in-vehicle device installed in a vehicle, and receive transmission target data; a service execution unit configured to execute a predetermined service; and a learning unit configured to learn a transmission condition for the transmission target data by the in-vehicle device, by evaluating an extent to which the transmission target data received by the communication unit has been used by the service execution unit. The learning unit specifies the transmission condition, during a learning period in which the communication unit receives the transmission target data that is repeatedly transmitted. The communication unit transmits the transmission condition specified by the learning unit to the in-vehicle device. Thus, the in-vehicle device having received the transmission condition can appropriately reduce the frequency with which the in-vehicle device uploads the data to the roadside device, whereby useless upload can be inhibited.

(14) A control method according to a seventh aspect of the present disclosure is a control method for an in-vehicle device installed in a vehicle, and the method includes: a communication step of receiving reception target data from a roadside device that is a device located outside the vehicle; and a learning step of learning a reception condition for the reception target data by evaluating an extent to which the reception target data received by the communication unit has been used by a function control device installed in the vehicle. The learning step includes specifying the reception condition, during a learning period in which the reception target data is repeatedly received in the communication step. The communication step includes receiving the reception target data according to whether or not the reception condition is satisfied, after the reception condition has been specified in the learning step. Thus, the frequency with which the in-vehicle device downloads the data of the service provided from the roadside device can be appropriately reduced without degrading the quality of the connected service, whereby useless download can be inhibited.

(15) A control method according to an eighth aspect of the present disclosure is a control method for an in-vehicle device installed in a vehicle, and the method includes: a communication step of receiving reception target data from a roadside device that is a device located outside the vehicle; and a learning step of learning propriety of reception of the reception target data in the communication step. The learning step includes: an acquisition step of acquiring output data of a function control device installed in the vehicle, and traveling state data indicating a traveling state of the vehicle; a surrounding situation detection step of generating surrounding situation data indicating a surrounding situation of the vehicle; an evaluation step of generating an evaluation index that evaluates traveling of the vehicle from the output data, during a predetermined period in which the reception target data is repeatedly received in the communication step; a determination step of determining whether or not the reception target data has been effectively used by the function control device, by comparing the evaluation index obtained when the reception target data has been received with the evaluation index obtained when the reception target data has not been received, during the predetermined period; and a step of causing a model to perform machine learning by using learning data, the model outputting data indicating the propriety of reception according to input data including the traveling state data and the surrounding situation data. The communication step includes receiving the reception target data according to output data of the model after learning. The learning data includes, as the input data, the traveling state data and the surrounding situation data that have been collected during the predetermined period, and includes, as the output data of the model, results of determination in the determination step that have been collected during the predetermined period. Thus, the frequency with which the in-vehicle device downloads the data of the service provided from the roadside device can be appropriately reduced without degrading the quality of the connected service, whereby useless download can be inhibited.

(16) A control method according to a ninth aspect of the present disclosure is a control method for an in-vehicle device installed in a vehicle, and the method includes: a communication step of transmitting transmission target data to a roadside device that is a device located outside the vehicle, and receiving, from the roadside device, an evaluation index indicating an extent to which the transmission target data has been used by the roadside device; and a learning step of learning a transmission condition for the transmission target data by using the evaluation index. The learning step includes specifying the transmission condition, during a learning period in which the transmission target data is repeatedly transmitted in the communication step. The communication step includes transmitting the transmission target data according to whether or not the transmission condition is satisfied, after the transmission condition has been specified in the learning step. Thus, the frequency with which the in-vehicle device uploads data to the roadside device can be appropriately reduced without degrading the quality of the connected service, whereby useless upload can be inhibited.

(17) A control method according to a tenth aspect of the present disclosure is a control method for an in-vehicle device installed in a vehicle, and the method includes: a communication step of transmitting transmission target data to a roadside device that is a device located outside the vehicle, and receiving, from the roadside device, an evaluation index that evaluates a service provided by the roadside device; and a learning step of learning propriety of transmission of the transmission target data in the communication step. The communication step includes transmitting, to the roadside device, traveling state data indicating a traveling state of the vehicle. The evaluation index is generated by the roadside device with the traveling state data and a surrounding situation of the vehicle being considered. The learning step includes: a surrounding situation detection step of generating surrounding situation data indicating the surrounding situation; a determination step of determining whether or not the transmission target data has been effectively used by the roadside device, by comparing the evaluation index obtained when the transmission target data has been transmitted with the evaluation index obtained when the transmission target data has not been transmitted, during a predetermined period in which the transmission target data is repeatedly transmitted in the communication step; and a step of causing a model to perform machine learning by using learning data, the model outputting data indicating the propriety of transmission according to input data including the traveling state data and the surrounding situation data. The communication step further includes transmitting the transmission target data according to output data of the model after learning. The learning data includes, as the input data, the traveling state data and the surrounding situation data that have been collected during the predetermined period, and includes, as the output data of the model, results of determination in the determination step that have been collected during the predetermined period. Thus, the frequency with which the in-vehicle device uploads data to the roadside device can be appropriately reduced without degrading the quality of the connected service, whereby useless upload can be inhibited.

(18) A computer program according to an eleventh aspect of the present disclosure is a computer program configured to cause a computer installed in a vehicle to realize: a communication function of receiving reception target data from a roadside device that is a device located outside the vehicle; and a learning function of learning a reception condition for the reception target data by evaluating an extent to which the reception target data received by the communication function has been used by a function control device installed in the vehicle. The learning function includes a function of specifying the reception condition, during a learning period in which the reception target data is repeatedly received by the communication function. The communication function includes a function of receiving the reception target data according to whether or not the reception condition is satisfied, after the reception condition has been specified by the learning function. Thus, the frequency with which the in-vehicle device downloads the data of the service provided from the roadside device can be appropriately reduced without degrading the quality of the connected service, whereby useless download can be inhibited.

(19) A computer program according to a twelfth aspect of the present disclosure is a computer program configured to cause a computer installed in a vehicle to realize: a communication function of receiving reception target data from a roadside device that is a device located outside the vehicle; and a learning function of learning propriety of reception of the reception target data by the communication function. The learning function includes: an acquisition function of acquiring output data of a function control device installed in the vehicle, and traveling state data indicating a traveling state of the vehicle; a surrounding situation detection function of generating surrounding situation data indicating a surrounding situation of the vehicle; an evaluation function of generating an evaluation index that evaluates traveling of the vehicle from the output data, during a predetermined period in which the reception target data is repeatedly received by the communication function; a determination function of determining whether or not the reception target data has been effectively used by the function control device, by comparing the evaluation index obtained when the reception target data has been received with the evaluation index obtained when the reception target data has not been received, during the predetermined period; and a function of causing a model to perform machine learning by using learning data, the model outputting data indicating propriety of reception according to input data including the traveling state data and the surrounding situation data. The communication function includes a function of receiving the reception target data according to the output data of the model after learning. The learning data includes, as the input data, the traveling state data and the surrounding situation data that have been collected during the predetermined period, and includes, as the output data of the model, results of determination by the determination function that have been collected during the predetermined period. Thus, the frequency with which the in-vehicle device downloads the data of the service provided from the roadside device can be appropriately reduced without degrading the quality of the connected service, whereby useless download can be inhibited.

(20) A computer program according to a thirteenth aspect of the present disclosure is a computer program configured to cause a computer installed in a vehicle to realize: a communication function of transmitting transmission target data to a roadside device that is a device located outside the vehicle, and receiving, from the roadside device, an evaluation index indicating an extent to which the transmission target data has been used by the roadside device; and a learning function of learning a transmission condition for the transmission target data according to the evaluation index. The learning function includes a function of specifying the transmission condition, during a learning period in which the transmission target data is repeatedly transmitted by the communication function. The communication function includes a function of transmitting the transmission target data according to whether or not the transmission condition is satisfied, after the transmission condition has been specified by the learning function. Thus, the frequency with which the in-vehicle device uploads data to the roadside device can be appropriately reduced without degrading the quality of the connected service, whereby useless upload can be inhibited.

(21) A computer program according to a fourteenth aspect of the present disclosure is a computer program configured to cause a computer installed in a vehicle to realize: a communication function of transmitting transmission target data to a roadside device that is a device located outside the vehicle, and receiving, from the roadside device, an evaluation index that evaluates a service provided by the roadside device; and a learning function of learning propriety of transmission of the transmission target data by the communication function. The communication function includes a function of transmitting, to the roadside device, traveling state data indicating a traveling state of the vehicle. The evaluation index is generated by the roadside device, with the traveling state data and a surrounding situation of the vehicle being considered. The learning function includes: a surrounding situation detection function of generating surrounding situation data indicating the surrounding situation, a determination function of determining whether or not the transmission target data has been effectively used by the roadside device, by comparing the evaluation index obtained when the transmission target data has been transmitted with the evaluation index obtained when the transmission target data has not been transmitted, during a predetermined period in which the transmission target data is repeatedly transmitted by the communication function, and a function of causing a model to perform machine learning by using learning data, the model outputting data indicating the propriety of transmission according to input data including the traveling state data and the surrounding situation data. The communication function further includes a function of transmitting the transmission target data according to output data of the model after learning. The learning data includes, as the input data, the traveling state data and the surrounding situation data that have been collected during the predetermined period, and includes, as the output data of the model, a result of determination by the determination function that has been collected during the predetermined period. Thus, the frequency with which the in-vehicle device uploads data to the roadside device can be appropriately reduced without degrading the quality of the connected service, whereby useless upload can be inhibited.

### Details of Embodiment of the Present Disclosure

In the embodiment below, the same components are denoted by the same reference signs. The names and functions of such components are also the same. Therefore, detailed descriptions thereof are not repeated.

### Overall Configuration

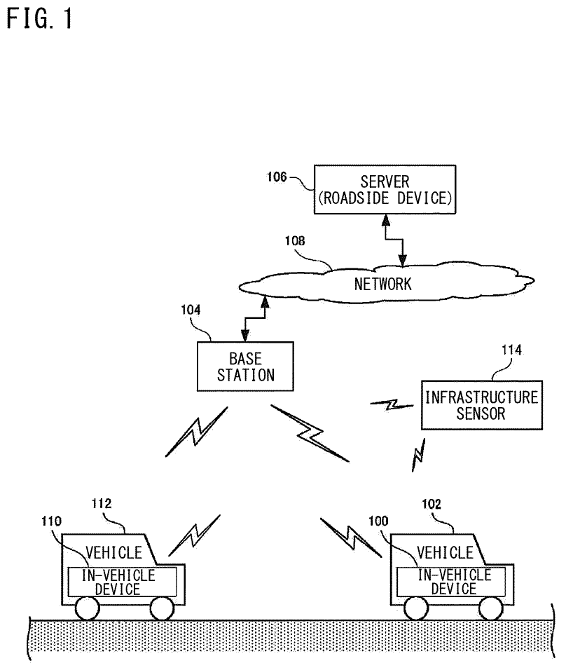

With reference to FIG. 1, a coordination system according to the embodiment of the present disclosure includes an in-vehicle device 100 and an in-vehicle device 110 installed in a vehicle 102 and a vehicle 112, respectively, a base station 104, and a server 106. The base station 104 is connected to a network 108 such as the Internet. The base station 104 is a base station for wireless communication such as cellular communication. The base station 104 provides mobile communication services by, for example, LTE (Long Term Evolution), 4G (fourth generation mobile communication system) network, 5G (fifth generation mobile communication system) network, etc. The server 106 and each of the in-vehicle device 100 and the in-vehicle device 110 are communicable with each other via the base station 104 and the network 108. The base station 104 may provide wireless communication functions such as Wi-Fi, C-V2X (Cellular-Vehicle to Everything), etc.

Each of the vehicle 102 and the vehicle 112 is equipped with a sensor such as an image sensor. Sensor data outputted from the sensors are acquired by the in-vehicle device 100 and the in-vehicle device 110, and are transmitted (uploaded) to the server 106. The server 106 executes services such as provision of driving support information, remote monitoring, remote control, etc., and uses, for the services, the sensor data received from the in-vehicle device 100 and the in-vehicle device 110. The server 106 just needs to be a device located outside the vehicle 102 and the vehicle 112. The server 106 may be a roadside device that is fixedly installed on or around a road.

An infrastructure sensor 114 is a device installed on or around a road and having a sensor function, and has a communication function with the base station 104. The infrastructure sensor 114 is, for example, an image sensor (digital monitoring camera, etc.), a radar (millimeter wave radar, etc.), a laser sensor (LiDAR (Light Detection and Ranging), etc.), or the like. The infrastructure sensor 114 may have a wireless communication function such as Wi-Fi or C-V2X, and may directly communicate with the in-vehicle device 100 and the in-vehicle device 110. The infrastructure sensor 114 transmits sensor data (moving image data, etc.) to the server 106 and to the in-vehicle device 100 and the in-vehicle device 110, directly or via the base station 104.

FIG. 1 illustratively shows one base station 104, one infrastructure sensor 114, and two vehicles 102 and 112 each being equipped with an in-vehicle device. However, this is merely an example. Usually, a plurality of base stations and a plurality of infrastructure sensors are installed, and three or more vehicles are equipped with in-vehicle devices. A vehicle not equipped with an in-vehicle device may exist. Such a vehicle not equipped with an in-vehicle device is a detection target for a sensor installed in a vehicle equipped with an in-vehicle device, and an infrastructure sensor.

### Hardware Configuration of In-Vehicle Device

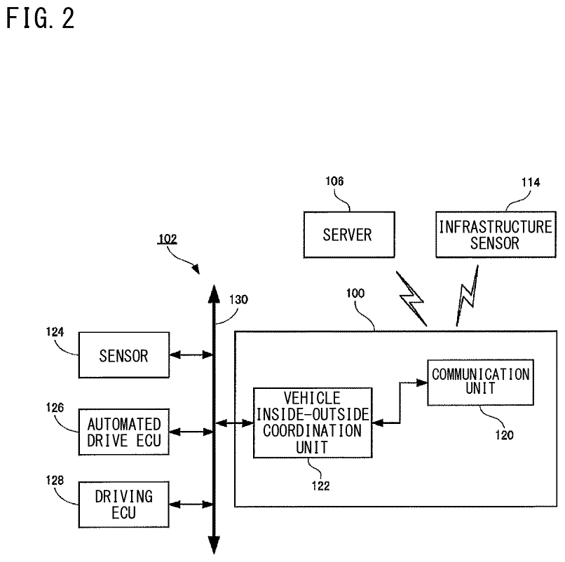

FIG. 2 shows an example of a hardware configuration of the in-vehicle device 100 installed in the vehicle 102. The in-vehicle device 110 installed in the vehicle 112 is similarly configured. The in-vehicle device 100 includes a communication unit 120 and a vehicle inside-outside coordination unit 122. FIG. 2 shows a communication unit 120, a sensor 124, an automated drive ECU 126, a driving ECU 128, and a bus 130 which are installed in the vehicle 102. In the vehicle 102, a plurality of ECUs are installed as devices for controlling various functions of the vehicle (i.e., function control devices). In FIG. 2, the automated drive ECU 126 and the driving ECU 128 are shown as representatives.

The communication unit 120 wirelessly communicates with devices outside the vehicle 102 via the base station 104. The communication unit 120 includes an IC (Integrated Circuit) for performing modulation and multiplexing adopted in wireless communication services provided by the base station 104, an antenna for transmitting and receiving radio waves of a predetermined frequency, an RF circuit, and the like. The communication unit 120 also has a communication function with a GNSS (Global Navigation Satellite System) such as a GPS (Global Positioning System). The communication unit 120 may have a wireless communication function such as Wi-Fi or C-V2X to directly communicate with the infrastructure sensor 114.

The vehicle inside-outside coordination unit 122 plays a role (i.e., communication protocol conversion, etc.) in connecting a communication function (i.e., communication specification) outside of the vehicle, to a communication function (i.e., communication specification) inside the vehicle. The automated drive ECU 126 is communicable with an external device via the vehicle inside-outside coordination unit 122 and the communication unit 120. The vehicle inside-outside coordination unit 122 receives driving support information from the server 106 via the communication unit 120, and transfers the information to the automated drive ECU 126. In addition, the vehicle inside-outside coordination unit 122 receives sensor data from the infrastructure sensor 114 via the communication unit 120. The bus 130 performs a communication function inside the vehicle. Regarding the vehicle inside-outside coordination unit 122, the sensor 124, the automated drive ECU 126, and the driving ECU 128, communication (i.e., data exchange) between them is performed via the bus 130. As the bus 130, for example, Ethernet (registered trademark), CAN (Controller Area Network), or the like is used.

The sensor 124 is installed in the vehicle 102, and includes sensors for acquiring information inside and outside the vehicle 102. The sensor for acquiring information outside the vehicle includes an imaging device (e.g., a digital camera (CCD camera, CMOS camera)), a radar, a laser sensor, etc. The sensor for acquiring information inside the vehicle includes an imaging device. The sensor 124 acquires information within a detection range (e.g., an imaging range of a camera), and outputs the information as sensor data. If a digital camera is adopted, the digital camera outputs digital moving image data. A detection signal (analog or digital) of the sensor 124 is outputted as digital data to the bus 130 via an interface unit (not shown), and is transmitted to the vehicle inside-outside coordination unit 122, the automated drive ECU 126, etc.

The automated drive ECU 126 controls traveling of the vehicle 102. For example, the automated drive ECU 126 acquires the sensor data, analyzes the sensor data to grasp the situation around the vehicle, generates control information (e.g., information on acceleration (deceleration), speed, heading direction, etc.) in consideration of the current traveling state (e.g., position, speed, etc.) of the vehicle 102, and outputs the control information to the driving ECU 128. The driving ECU 128 controls the mechanisms related to automated driving (i.e., mechanisms such as the engine, transmission, steering, brake, etc.) by using the control information inputted from the automated drive ECU 126. The automated drive ECU 126 can use the driving support information (i.e., dynamic information, etc.) acquired from the vehicle inside-outside coordination unit 122, for generation of the control information. The automated drive ECU 126 acquires the information indicating the current traveling state (e.g., position, speed, etc.) of the vehicle 102 from the GPS and the driving ECU 128. For example, position information can be generated from GPS data, and speed information can be acquired from the automated drive ECU 126.

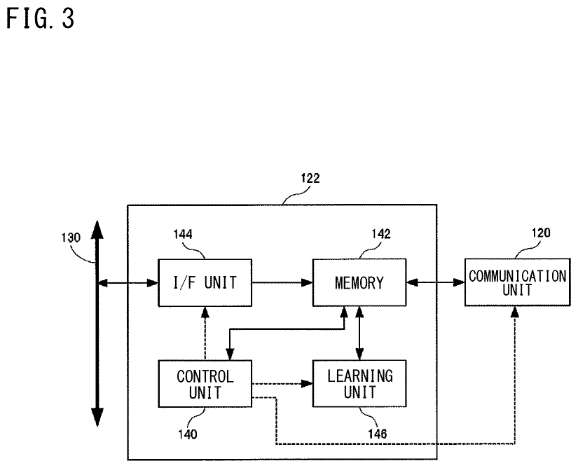

With reference to FIG. 3, the vehicle inside-outside coordination unit 122 includes a control unit 140, a memory 142, an I/F unit 144, and a learning unit 146. The control unit 140 is configured to include a CPU (Central Processing Unit), and controls the memory 142, the I/F unit 144, and the communication unit 120 (a control signal is represented by a dotted arrow). The memory 142 is, for example, a rewritable nonvolatile semiconductor memory, and has, stored therein, a computer program (hereinafter simply referred to as “program”) that the control unit 140 executes. The memory 142 provides a work area for the program that the control unit 140 executes. In addition, the memory 142 stores therein data received from the outside via the communication unit 120 (sensor data from the infrastructure sensor 114, download data from the server 106, etc.).

The I/F unit 144 serves as an interface with the sensor 124, the automated drive ECU 126, and the driving ECU 128 (see FIG. 2), under control of the control unit 140. Data that the I/F unit 144 has acquired from the sensor 124, the automated drive ECU 126, and the driving ECU 128 are stored in the memory 142. The data acquired from the sensor 124 (i.e., sensor data) is data to be transmitted to the server 106. The communication unit 120 generates packet data from upload data stored in the memory 142, and transmits the packet data, under control of the control unit 140. If the sensor data is moving image data, the data sequentially acquired from the sensor 124 is buffered by a predetermined amount into the memory 142, and data to be transmitted is generated from the buffered data and is sequentially transmitted.

The learning unit 146 learns a condition for downloading data from the server 106 (i.e., reception condition) and a condition for uploading data to the server 106 (i.e., transmission condition) in order to appropriately reduce the communication frequency, as described later. Learning results are stored in the memory 142. Various data are downloaded from the server 106. Download data subject to the reception condition (hereinafter, also referred to as “reception target data”) is data of a service provided by the server 106 (i.e., driving support information, etc.). Meanwhile, various data are uploaded to the server 106. Upload data subject to the transmission condition (hereinafter, also referred to as “transmission target data”) is data that can be used for a service provided by the server 106 (i.e., sensor data acquired from the sensor 124, etc.).

### Hardware Configuration of Server

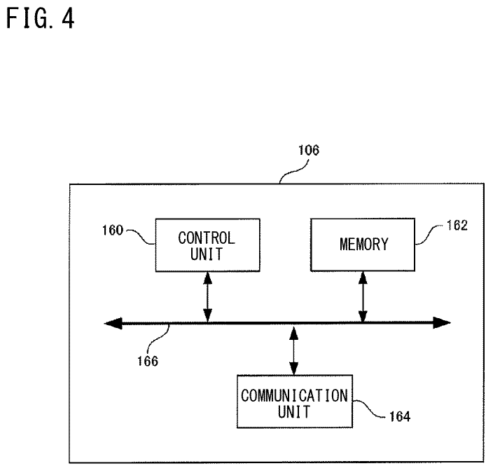

With reference to FIG. 4, the server 106 includes a control unit 160, a memory 162, a communication unit 164, and a bus 166. Data transfer between these components is performed via the bus 166. The control unit 160 includes a CPU, controls each component, and realizes various services. The communication unit 164 receives information (i.e., sensor data, vehicle information, etc.) uploaded from the in-vehicle device 100 and the in-vehicle device 110 via the base station 104 and the network 108. The memory 162 includes a rewritable nonvolatile semiconductor memory and a mass storage device such as a HDD (Hard Disk Drive). The data received by the communication unit 164 is transferred to and stored in the memory 162. The data uploaded and stored in the memory 162 is used by an application program (hereinafter, also simply referred to as “application”) for realizing a service. The communication unit 164 has a function of accessing the network 108 wirelessly or by wire. The communication unit 164 reads out download data (i.e., service data, etc.) from the memory 162, and transmits the download data to the vehicle 102 and the vehicle 112, under control of the control unit 160. The server 106 includes an operation unit (not shown) such as a computer keyboard and mouse for an administrator or the like to input an instruction to the control unit 160.

### Software Configuration

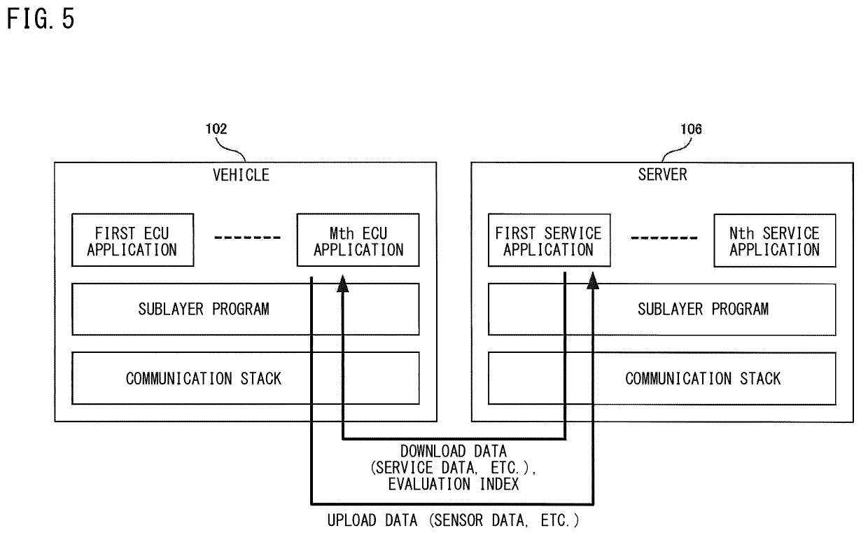

With reference to FIG. 5, software of the coordination system constituted by the vehicle 102 and the server 106 is hierarchically configured. The hierarchical configuration shown in FIG. 5 corresponds to, for example, a hierarchical configuration of an OSI (Open Systems Interconnection) reference model. The vehicle 102 includes a plurality of ECUs as described above, and includes, in an upper layer, application programs (from a first ECU application to an Mth ECU application) for realizing the functions of the ECUs. The applications in the upper layer are executed in parallel by microcomputers or the like mounted in the respective ECUs. The upper layer corresponds to, for example, an application layer of the OSI reference model. The vehicle 102 includes, in a lower layer, a communication stack (corresponding to, for example, a session layer and lower layers in the OSI reference model) for communication with the outside, and includes, in an intermediate layer, a sublayer program that mediates the programs in the upper layer and the programs in the lower layer. The intermediate layer corresponds to, for example, a presentation layer in the OSI reference model.

The function of the vehicle inside-outside coordination unit 122 (or the corresponding program) in the in-vehicle device 100 is mainly positioned in the sublayer program. The vehicle inside-outside coordination unit 122 controls the communication stack in the lower layer, and transmits the transmission target data (i.e., sensor data acquired from the sensor 124, etc.) to the server 106, as described above. In addition, the vehicle inside-outside coordination unit 122 controls the communication stack in the lower layer, receives the reception target data (i.e., driving support information, etc.) from the server 106 as described above, and transfers the received data to, for example, the automated drive ECU 126 (see FIG. 2). The vehicle inside-outside coordination unit 122 controls the communication stack in the lower layer, and receives, from the server 106, an evaluation index to be used for specifying a transmission condition for the transmission target data, as described later. The function of the vehicle inside-outside coordination unit 122 (or the corresponding program) may include part of the plurality of applications in the upper layer. That is, the vehicle inside-outside coordination unit 122 may include a function as an ECU.

The server 106 executes a plurality of services (i.e., driving support, remote monitoring, remote control, etc.) as described above, and includes, in an upper layer, application programs for realizing the respective services (from a first service application to an Nth service application). The server 106 includes, in a lower layer, a communication stack for communication with the outside (i.e., the in-vehicle device 100 of the vehicle 102, etc.), and includes, in an intermediate layer, a sublayer program that mediates the programs in the upper layer and the programs in the lower layer. For example, the upper layer, the intermediate layer, and the lower layer respectively correspond to an application layer, a presentation layer, and a session layer and lower layers, in an OSI reference model.

A program for realizing an infrastructure coordination unit that constitutes a coordination system through communication with the in-vehicle device 100 of the vehicle 102 is positioned in the sublayer program. The programs in the upper layer and the intermediate layer are executed as multitask by the control unit 160 (see FIG. 4). The infrastructure coordination unit controls the communication stack in the lower layer, and transmits service data (i.e., driving support information, etc.) provided from the program in the upper layer, to the in-vehicle device 100 of the vehicle 102. In addition, the infrastructure coordination unit controls the communication stack in the lower layer, receives sensor data, etc., uploaded from the vehicle 102, and transfers the received data to the program in the upper layer, as described above. The infrastructure coordination unit monitors the operation of the program in the upper layer, and generates an evaluation index indicating how effectively the sensor data, etc., transferred to the program in the upper layer is used by the program in the upper layer. The server 106 controls the communication stack in the lower layer, and transmits the evaluation index to the corresponding in-vehicle device.

### Functional Configuration Related to Download

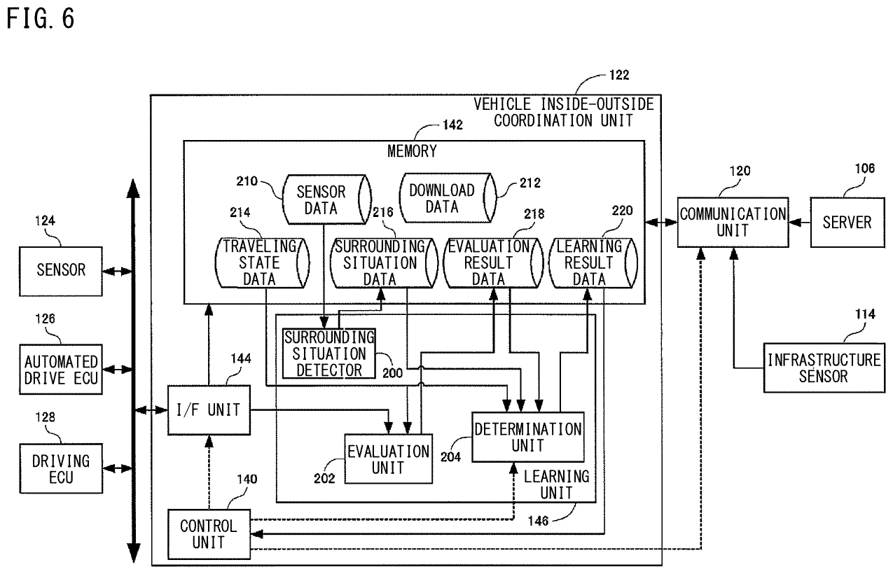

The download function of the vehicle inside-outside coordination unit 122 will be described with reference to FIG. 6. As shown in FIG. 4, the vehicle inside-outside coordination unit 122 includes the control unit 140, the memory 142, the I/F unit 144, and the learning unit 146. The learning unit 146 includes a surrounding situation detection unit 200, an evaluation unit 202, and a determination unit 204.

The memory 142 has, stored therein, sensor data 210, download data 212, traveling state data 214, surrounding situation data 216, evaluation result data 218, and learning result data 220. The sensor data 210 includes sensor data outputted from the sensor 124, and sensor data received from the infrastructure sensor 114 via the communication unit 120. The download data 212 includes reception target data received from the server 106 via the communication unit 120. The traveling state data 214 is data indicating the traveling state (e.g., position, speed, etc.) of the vehicle 102. The traveling state data is acquired from the automated drive ECU 126 by the I/F unit 144. The surrounding situation data 216 is data indicating the situation related to the traffic around the vehicle 102 (i.e., traffic accident, traffic jam, etc.), and is detected by the surrounding situation detection unit 200 as described later. The evaluation result data 218 is data indicating how effectively the download data is used by the automated drive ECU 126, and is generated by the evaluation unit 202 as described later. The learning result data 220 includes a condition for executing communication with the server 106 (i.e., reception condition), and is specified by the determination unit 204 as described later. The sensor data 210, the download data 212, the traveling state data 214, the surrounding situation data 216, and the evaluation result data 218 are each stored, with corresponding time information (e.g., a time stamp when the data is stored in the memory 142) being attached thereto. The time information may not necessarily be attached to each data, and one piece of time information (e.g., a representative value of time stamps) may be attached to a set of data that are temporally close to each other. Storing the data with the time information allows mutually corresponding data (or data sets) to be specified by using the time information.

The I/F unit 144 is controlled by the control unit 140, acquires the sensor data outputted from the sensor 124, and stores the acquired sensor data as the sensor data 210 into the memory 142. The communication unit 120 stores the sensor data received from the infrastructure sensor 114 as the sensor data 210 into the memory 142. The I/F unit 144 acquires the data indicating the traveling state (e.g., position, speed, etc.) of the vehicle 102 from the automated drive ECU 126, and stores the acquired data as the traveling state data 214 into the memory 142.

The surrounding situation detection unit 200 reads out the sensor data 210 from the memory 142, detects the surrounding situation of the own vehicle (i.e., vehicle 102), and stores the detection result as the surrounding situation data 216 into the memory 142. The surrounding situation data is data indicating, for example, existence of a traffic accident, a traffic jam, or a blind spot (e.g., an area that cannot be directly seen, such as an intersection), and includes, for example, data indicating the type of the situation, and position coordinates indicating an area where the situation occurs. If the sensor data 210 is image data (i.e., moving image data, etc.), the surrounding situation detection unit 200 can extract objects (i.e., dynamic objects such as vehicles, and static objects such as buildings and road signs) to generate surrounding situation data.

The evaluation unit 202 acquires output data (i.e., control information) from the automated drive ECU 126 to the driving ECU 128, generates an evaluation index, and stores the evaluation index as the evaluation result data 218 into the memory 142. The output data of the automated drive ECU 126 depends on the traveling state of the vehicle 102, and the surrounding situation of the vehicle 102. In addition, if the download data 212 (i.e., driving support information, etc.) has been received, since the automated drive ECU 126 can generate the output data by also using the download data 212, the output data of the automated drive ECU 126 also depends on the download data 212. Assuming that the output data of the automated drive ECU 126 in the case where the download data 212 is not used is Y1 and the output data in the case where the download data 212 is used is Y2, Y1 and Y2 are expressed as Y1=f(X1) and Y2=(X1,X2) by using a predetermined function (specifically, algorithm) f. X1 indicates a set of traveling state data and surrounding situation data, and X2 indicates the download data 212. For example, if blind spot information (e.g., information on a dynamic object that cannot be acquired by the sensor 124 of the vehicle 102) can be acquired as X2, the output data of the automated drive ECU 126 (e.g., the control information of the driving ECU 128) varies depending on whether or not the automated drive ECU 126 uses the blind spot information. The output data of the automated drive ECU 126 is usually composed of a plurality of parameters (i.e., parameters such as acceleration (deceleration), speed, and heading direction), and each of Y1 and Y2 is treated as a vector.

The evaluation unit 202 generates an evaluation index of the output data of the automated drive ECU 126, from Y1 and Y2. Since the driving ECU 128 is controlled by the output data of the automated drive ECU 126, this evaluation index evaluates traveling of the own vehicle. Assuming that the evaluation index in the case where the download data 212 is not used is Z1 and the evaluation index in the case where the download data 212 is used is Z2, Z1 and Z2 are expressed as Z1=g(Y1) and Z2=g(Y2) by using a predetermined function (specifically, model) g. The evaluation index is, for example, any one of safety, comfort, traffic efficiency, etc., or any combination thereof. The safety is represented (i.e., quantified) by, for example, the number of sudden stops, sudden decelerations, etc., specified from the time-series output data of the automated drive ECU 126. The comfort is, for example, riding comfort in the vehicle, and is quantified by vibration (i.e., amplitude and frequency) or the like of the own vehicle, specified from the time-series output data of the automated drive ECU 126. The traffic efficiency is, for example, a link travel time (e.g., travel time for a predetermined distance), and is calculated from time-series traveling state data 214.

Under control of the control unit 140, the determination unit 204 reads the evaluation indices Z1 and Z2 from the evaluation result data 218, and determines whether or not there is a significant difference between Z1 and Z2. Specifically, if the function g is set such that the more effectively the download data 212 is used, the larger the evaluation index becomes, the determination unit 204 calculates a difference ΔZ between Z1 and Z2 (i.e., ΔZ=Z2−Z1), and determines whether or not the difference ΔZ is larger than a predetermined threshold value Th. If the function g is set such that the more effectively the download data 212 is used, the smaller the evaluation index becomes, the determination unit 204 calculates a difference ΔZ according to ΔZ=Z1−Z2. In either case, the difference ΔZ is a difference with respect to the evaluation index Z1 (difference (≥0) based on the evaluation index Z1) in the case where the download data 212 is not used. If ΔZ>Th, data corresponding to Z2 is read out from the traveling state data 214 and the surrounding situation data 216, and is stored as the learning result data 220 into the memory 142. If the evaluation index in the case where the download data 212 is used is separated by more than Th from the evaluation index in the case where the download data 212 is not used, it is considered that the download data 212 has been effectively used by the automated drive ECU 126. Therefore, if a similar state is detected thereafter, the reception target data may be downloaded from the server 106. Meanwhile, if the evaluation index in the case where the download data 212 is used is separated by only Th or less from the evaluation index in the case where the download data 212 is not used, it is difficult to consider that the download data 212 has been effectively used by the automated drive ECU 126. That is, download performed in such a state is useless.

During a predetermined period (hereinafter referred to as “learning period”), the control unit 140 controls the communication unit 120, and repeatedly (e.g., periodically) downloads the reception target data. The control unit 140 transmits a predetermined request (hereinafter referred to as “download request”) to the server 106, whereby download is executed. Each of the surrounding situation detection unit 200, the evaluation unit 202, and the determination unit 204 executes a process at a predetermined timing. As a result, the learning result data 220 is accumulated. After the learning period has elapsed, the control unit 140 reads out the latest traveling state data 214 and surrounding situation data 216, and determines whether or not the read data satisfies the reception condition, that is, whether or not the read data corresponds to the learning result data 220. If the read data satisfies the reception condition, the control unit 140 controls the communication unit 120, transmits a download request to the server 106, and downloads the reception target data. If the read data does not satisfy the reception condition, the control unit 140 does not perform download. Therefore, the vehicle inside-outside coordination unit 122 executes download when there is a high possibility that the reception target data (i.e., data, such as driving support information, of the connected service provided by the server 106) is effectively used. Otherwise, the vehicle inside-outside coordination unit 122 does not perform download. That is, the frequency with which the in-vehicle device 100 downloads the data of the service provided from the server 106 (i.e., roadside device, etc.) can be appropriately reduced without degrading the quality of the connected service, whereby useless download can be inhibited.

As described above, the evaluation index just needs to include at least one of comfort, traffic efficiency, and safety. This allows appropriate determination as to whether or not the downloaded data has been effectively used.

### Operation (Download) of Vehicle Inside-Outside Coordination Unit

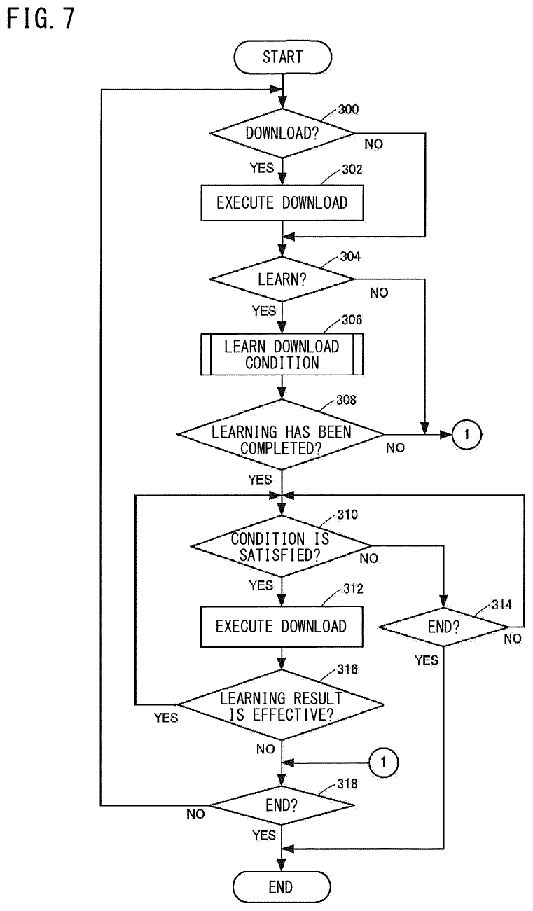

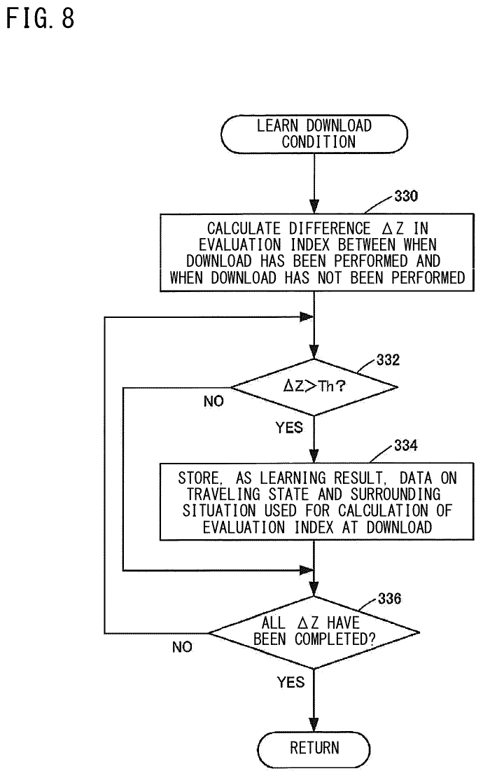

With reference to FIG. 7 and FIG. 8, the operation of the vehicle inside-outside coordination unit 122 related to download will be described while referring to the functions shown in FIG. 6. The process shown in FIG. 7 is realized by the control unit 140 reading out a predetermined program from the memory 142, and executing the program. The process shown in FIG. 7 is started, for example, when the in-vehicle device 100 is powered on. It is assumed that a learning period T, a download cycle ΔT1 and a learning cycle ΔT2 (e.g., ΔT2>ΔT1) during the learning period, a threshold value Th, etc., are stored in the memory 142 in advance. It is assumed that the sensor data 210 and the download data 212 are periodically given time stamps and stored in the memory 142. In addition, it is assumed that each of the surrounding situation detection unit 200 and the evaluation unit 202 periodically executes the above process, and stores the surrounding situation data 216 and the evaluation result data 218 with time stamps attached thereto. Usually, each of the sensor data 210, the download data 212, the surrounding situation data 216, and the evaluation result data 218 is deleted in order from the oldest, so that a predetermined amount of data is stored.

In step 300, the control unit 140 determines whether or not to execute download. Specifically, the control unit 140 determines whether or not the cycle ΔT1 has elapsed from when the previous download was executed. When the determination result is that the cycle ΔT1 has elapsed, the control proceeds to step 302. Otherwise, the control proceeds to step 304. When step 300 is executed for the first time, the control unit 140 determines to execute download. The control unit 140 may acquire the current time from, for example, a clock installed in the in-vehicle device 100.

In step 302, the control unit 140 controls the communication unit 120, and downloads the reception target data from the server 106. Specifically, the control unit 140 transmits a download request to the server 106. Thereafter, the control proceeds to step 304. Upon receiving the download request, the server 106 specifies a transmission source address of packet data to specify the vehicle 102 (specifically, the in-vehicle device 100) that has transmitted the download request, and transmits the reception target data.

In step 304, the control unit 140 determines whether or not to perform learning. Specifically, the control unit 140 determines whether or not the cycle ΔT2 has elapsed from when the previous learning was executed. When the determination result is that the cycle ΔT2 has elapsed, the control proceeds to step 306. Otherwise, the control proceeds to step 318. When step 304 is executed for the first time, the control unit 140 determines to perform learning.

In step 306, the control unit 140 executes learning of the download condition (i.e., reception condition). Specifically, the control unit 140 executes the process shown in FIG. 8.

With reference to FIG. 8, in step 330, the control unit 140 reads out the evaluation result data 218 stored in the memory 142, and calculates the difference ΔZ(≥0) between the evaluation index Z2 obtained when the reception target data has been downloaded and the evaluation index Z1 obtained when the reception target data has not been downloaded. The evaluation index Z2 to be processed is one that has not been processed until then. The evaluation indices Z2 and Z1 used for calculating the difference are, for example, those to which time information items closest to each other are attached. If the number of the evaluation indices Z2 is less than the number of the evaluation indices Z1, calculation of the difference ΔZ may use: a representative value (e.g., average value) of evaluation indices Z1 positioned between every adjacent two evaluation indices Z2 when the indices are arranged in time series; and one of the adjacent two evaluation indices Z2. The control unit 140 attaches time information to the calculated difference ΔZ, and stores the difference ΔZ into the memory 142. As the time information, for example, the time information attached to the evaluation index Z2 used for calculating the difference may be used. Thereafter, the control proceeds to step 332.

In step 332, the control unit 140 determines whether or not the difference ΔZ calculated in step 330 is larger than the threshold value Th. If ΔZ>Th, the control proceeds to step 334. Otherwise, the control proceeds to step 336.

In step 334, the control unit 140 specifies the traveling state data and the surrounding situation data used for calculating the evaluation index Z2 (i.e., evaluation index at the time of download) determined to be ΔZ>Th in step 332, and stores them as the learning result data 220. To specify the traveling state data and the surrounding situation data, the time information attached thereto may be compared with the time information attached to the corresponding evaluation index Z2. The control unit 140 specifies the traveling state data and the surrounding situation data to which time information that is the same as or close within a predetermined range to the time information attached to the evaluation index Z2, is attached.

In step 336, the control unit 140 determines whether or not step 332 has been executed for all the differences ΔZ calculated in step 330 previously executed. When the determination result is that step 332 has been executed for all the differences ΔZ, the control proceeds to step 308 in FIG. 7. Otherwise, the control returns to step 332.

Referring back to FIG. 7, in step 308, the control unit 140 determines whether or not the learning has been completed. Specifically, the control unit 140 determines whether or not the learning period T has elapsed. When the determination result is that the learning has been completed, the control proceeds to step 310. Otherwise, the control proceeds to step 318.

In step 310, the control unit 140 reads out the latest traveling state data 214 and surrounding situation data 216 from the memory 142, and determines whether or not the read data satisfy the download condition (i.e., reception condition). Specifically, the control unit 140 determines whether or not a set of traveling state data 214 and surrounding situation data 216, whose values are the same as or close within a predetermined range to the values of the read traveling state data 214 and surrounding situation data 216, is stored in the learning result data 220. When the determination result is that such a set is stored, the control proceeds to step 312. Otherwise, the control proceeds to step 314.

In step 312, the control unit 140 executes download in the same manner as in step 302. That is, the control unit 140 transmits a download request to the server 106, and receives the reception target data transmitted from the server 106. Thereafter, the control proceeds to step 316.

When the determination result in step 310 is NO, in step 314, the control unit 140 determines whether or not an end instruction has been received. When the determination result is that an end instruction has been received, this program is ended. Otherwise, the control returns to step 310. The end instruction is made by powering off the in-vehicle device 100, for example.

In step 316, the control unit 140 determines whether or not the current learning result is effective. Specifically, the control unit 140 reads out, from the memory 142, the evaluation index Z2 (i.e., the latest evaluation result data 218) of the result that the reception target data, downloaded in the just previously executed step 312, has been used by the automated drive ECU 126. Then, the control unit 140 calculates a difference ΔZ in the same manner as described above, and compares the difference ΔZ with the threshold value Th. As the evaluation index Z1 to be a reference when calculating the difference, a representative value (e.g., average value, median value, etc.) of the evaluation indices Z1 in the learning period may be used. If ΔZ>Th, the current learning result (i.e., the learning result data 220 stored in the memory 142) is determined to be effective, and the control returns to step 310. Otherwise, the control unit 140 deletes the learning result data 220 stored in the memory 142, and the control proceeds to step 318.

In step 318, as in step 314, the control unit 140 determines whether or not an end instruction has been received. When the determination result is that an end instruction has been received, this program is ended. Otherwise, the control returns to step 300.

As described above, by repeating the processes in steps 300 to 308, download and learning of the download condition (reception condition) are periodically executed until the learning is competed (until the learning period elapses). Although the download and learning are periodically executed in the above description, the present disclosure is not limited thereto. The frequency of repeatedly executed download just needs to be higher than the frequency of repeatedly executed learning. After completion of the learning, the processes in steps 310 to 316 are repeated, whereby whether or not to execute download is determined by using the learning result, and download is executed only when the download condition is satisfied. Therefore, the frequency with which the in-vehicle device 100 downloads the data of the service provided from the server 106 (i.e., roadside device, etc.) can be appropriately reduced without degrading the quality of the connected service, whereby useless download can be inhibited.

When the learning result data 220 stored in the memory 142 has become no longer effective (i.e., when there is no significant difference between the evaluation index Z2 and the evaluation index Z1 (specifically, when the determination result in step 316 is NO)), relearning is executed. That is, the control returns to step 300, and periodical download and learning of the download condition (i.e., reception condition) are executed again. Thus, when the learning result has become no longer effective, relearning is quickly executed, and an appropriate reception condition can be determined again.

In the above description, whether or not the learning result is effective is determined, and relearning is executed when the learning result is no longer effective. However, the present disclosure is not limited thereto. Relearning may be intentionally executed without determining the effectiveness of the learning result. For example, when the automated drive ECU 126 has been updated, the output data of the automated drive ECU 126 may be changed even if the traveling state and the surrounding situation are not changed. Therefore, even in such a case, it is desirable to quickly execute relearning without using the learning result that was used before the update. This allows an appropriate reception condition to be quickly determined again. Update of the automated drive ECU 126 includes not only update of the program of the automated drive ECU 126 but also replacement with new type hardware.

### Functional Configuration Related to Upload

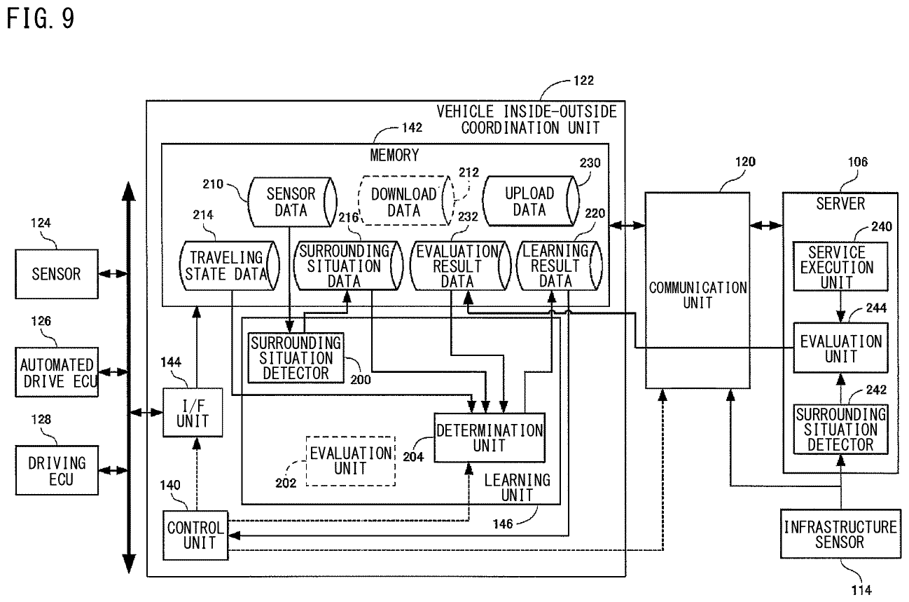

With reference to FIG. 9, the functions, related to upload, of the vehicle inside-outside coordination unit 122 and the server 106 will be described. The vehicle inside-outside coordination unit 122 is configured as shown in FIG. 6. In FIG. 9, the vehicle inside-outside coordination unit 122 has the same components as those shown in FIG. 6, and components not used for upload (i.e., the evaluation unit 202 and the download data 212) are indicated by broken lines. Regarding download, the evaluation index indicating the extent of effective use of the reception target data (i.e., download data) is adopted. Likewise, regarding upload, an evaluation index indicating the extent of effective use of the transmission target data (i.e., upload data) is adopted. As described later, since the main device that calculates the evaluation index related to upload is the server 106, the server 106 shown in FIG. 9 includes components necessary for that purpose. The “evaluation result data” stored in the memory 142 is acquired from the server 106, unlike the evaluation result data 218 shown in FIG. 6, and therefore is denoted by a reference sign “232” different from that in FIG. 6. In the following description, the same functions as those in download will not be repeatedly described, and different points will be mainly described.

The memory 142 has, stored therein, upload data 230 in addition to the pieces of data shown in FIG. 6. The upload data 230 is transmission target data to be uploaded, and is data (e.g., moving image data) to be effectively used by the server 106, among the sensor data 210 (i.e., the output data of the sensor 124). The transmission target data is transmitted with position information, etc., indicating the position at which the data was acquired. For example, when moving image data acquired by an in-vehicle camera or the like is uploaded as the transmission target data, information, which indicates the position at which the moving image data is acquired (i.e., at which the image is captured) and the imaging direction, is attached, whereby the server 106 can effectively use the result of analysis of the uploaded data, for generation of service data, etc. The evaluation result data 232 is data calculated by the evaluation unit 244 of the server 106 and received by the communication unit 120, as described later.

The server 106 includes a service execution unit 240, a surrounding situation detection unit 242, and an evaluation unit 244 to deal with upload from the vehicle inside-outside coordination unit 122. The service execution unit 240 has a function of executing connected services (e.g., provision of driving support information, remote monitoring, remote control, etc.) provided by the server 106. The service execution unit 240 generates service data by using the sensor data received from the infrastructure sensor 114 via the communication unit 164 (see FIG. 4), and provides the service data to the in-vehicle device 100, etc. When the server 106 has received the upload data, the server 106 also uses the received upload data to generate the service data.

The surrounding situation detection unit 242 detects the surrounding situation of a vehicle (i.e., vehicle 102) corresponding to the received transmission target data, from the sensor data received from the infrastructure sensor 114, and outputs the detection result to the evaluation unit 244. The detection result is stored in the memory 162 (see FIG. 4). From each vehicle to the server 106, data indicating the traveling state (e.g., position, speed, etc.) of the vehicle is repeatedly (e.g., periodically) transmitted and stored in the memory 162. If the transmission source address (e.g., IP address) can be changed, the data may be transmitted with information (e.g., ID) specifying the vehicle (specifically, the in-vehicle device) being attached thereto. The surrounding situation detection unit 242 can associate the position of the vehicle with the uploaded transmission target data by using the transmission source address and the time stamp of the data, and can detect, from the sensor data, the surrounding situation of the vehicle with reference to the position of the vehicle. As described above, the surrounding situation data is data indicating, for example, existence of a traffic accident, a traffic jam, or a blind spot (e.g., an area that cannot be directly seen, such as an intersection).

The evaluation unit 244 generates an evaluation index in the same manner as described regarding the evaluation unit 202. Unlike the evaluation unit 202, the evaluation unit 244 generates an evaluation index by evaluating the output data (i.e., service data) of the service execution unit 240. It is conceivable that the output data (i.e., driving support information, etc.) of the service execution unit 240 depends on the surrounding situation of the vehicle 102 detected by the surrounding situation detection unit 242 and on the uploaded transmission target data. For example, when the surrounding situation detection unit 242 has detected a traffic accident around the vehicle 102, from the sensor data acquired from the infrastructure sensor 114, the service execution unit 240 can generate more effective driving support information by using the transmission target data (e.g., moving image data, etc.) uploaded from the vehicle 102. Assuming that the output data of the service execution unit 240 in the case where the upload data 230 is not used is Y1 and the output data in the case where the upload data 230 is used is Y2, Y1 and Y2 are expressed as Y1=f(X1) and Y2=f(X1,X2) by using a predetermined function (specifically, algorithm) f. X1 indicates a set of traveling state data and surrounding situation data, and X2 indicates the upload data 230. The surrounding situation detection unit 242 generates each evaluation index from Y1 and Y2. Assuming that the evaluation index in the case where the upload data 230 is not used is Z1 and the evaluation index in the case where the upload data 230 is used is Z2, Z1 and Z2 are expressed as Z1=g(Y1) and Z2=g(Y2) by using a predetermined function (specifically, model) g. The evaluation index is, for example, the detection rate of traffic accidents or the like (i.e., the degree of omission detection).

Under control of the control unit 140, the determination unit 204 in the vehicle inside-outside coordination unit 122 reads out the evaluation indices Z1 and Z2 from the evaluation result data 232, and determines whether or not there is a significant difference between Z1 and Z2. Specifically, if the function g is set such that the more effectively the upload data 230 is used, the larger the evaluation index becomes, the determination unit 204 calculates a difference ΔZ between Z1 and Z2 (ΔZ=Z2−Z1), and determines whether or not the difference ΔZ is larger than the predetermined threshold value Th. If the function g is set such that the more effectively the upload data 230 is used, the smaller the evaluation index becomes, the determination unit 204 calculates a difference ΔZ according to ΔZ=Z1−Z2. In either case, the difference ΔZ is a difference with respect to the evaluation index Z1 (difference (≥0) based on the evaluation index Z1) in the case where the upload data 230 is not used. If ΔZ>Th, data corresponding to Z2 is read out from the traveling state data 214 and the surrounding situation data 216, and is stored as the learning result data 220 into the memory 142. A time stamp may be used to specify the data corresponding to Z2, from the traveling state data 214 and the surrounding situation data 216.

As described later, the server 106 receives data uploaded from a plurality of in-vehicle devices, repeatedly (e.g., periodically) generates evaluation indices, and broadcasts the evaluation indices. Therefore, assuming that clocks of the server 106 and the vehicle inside-outside coordination unit 122 are adjusted to indicate the same time, it is possible to specify, as an evaluation index Z2, an evaluation index to which a time stamp after and close to the time when the evaluation index was uploaded from the vehicle inside-outside coordination unit 122, is attached, among the evaluation indices that the vehicle inside-outside coordination unit 122 receives from the server 106. The other evaluation indices may be evaluation indices Z1.

As described above, the evaluation result data 232 is the evaluation index that is received from the server 106 by the vehicle inside-outside coordination unit 122, and that is detected by the surrounding situation detection unit 242 of the server 106. Meanwhile, the surrounding situation data 216 is detected by the surrounding situation detection unit 200. Although the detection result by the surrounding situation detection unit 200 is not necessarily the same as the detection result by the surrounding situation detection unit 242, these detection results are expected to be similar because both the surrounding situation detection unit 200 and the surrounding situation detection unit 242 detect the surrounding situation of the vehicle 102. Therefore, as data corresponding to the evaluation index Z2, the surrounding situation data 216 as the detection result of the surrounding situation detection unit 200 can be used.

If the evaluation index in the case where the upload data 230 is used is separated by more than Th from the evaluation index in the case where the upload data 230 is not used, it is considered that the upload data 230 has been effectively used by the server 106 (specifically, the service execution unit 240). Therefore, if a similar state is detected thereafter, the transmission target data may be uploaded to the server 106. Meanwhile, if the evaluation index in the case where the upload data 230 is used is separated by only Th or less from the evaluation index in the case where the upload data 230 is not used, it is difficult to consider that the upload data 230 has been effectively used by the server 106. That is, upload performed in such a state is useless.

In a predetermined learning period, the control unit 140 controls the communication unit 120 to repeatedly (e.g., periodically) upload the transmission target data. Each of the surrounding situation detection unit 200 and the determination unit 204 executes a process at a predetermined timing. The evaluation index transmitted from the server 106 is received by the communication unit 120, and is stored as the evaluation result data 232 in the memory 142. Thus, learning result data 220 is accumulated. After the learning period has elapsed, the control unit 140 reads out the latest traveling state data 214 and surrounding situation data 216, and determines whether or not the read data satisfies the transmission condition, i.e., whether or not the read data corresponds to the learning result data 220. If the read data satisfies the transmission condition, the control unit 140 controls the communication unit 120 to upload the transmission target data to the server 106. If the read data does not satisfy the transmission condition, the control unit 140 does not perform upload. Therefore, the vehicle inside-outside coordination unit 122 executes upload when there is a high possibility that the transmission target data (i.e., data, such as sensor data, which can be used in the connected service provided by the server 106) is effectively used. Otherwise, the vehicle inside-outside coordination unit 122 does not execute upload. That is, the frequency of uploading data from the in-vehicle device 100 to the server 106 (i.e., roadside device or the like) can be appropriately reduced without degrading the quality of the connected service, whereby useless upload can be inhibited.

As described above, the communication unit 120 transmits, to the server 106, the traveling state data indicating the traveling state of the vehicle 102, and the evaluation index is generated by the server 106 (specifically, the evaluation unit 244) taking into account the traveling state and the surrounding situation of the vehicle. The learning unit 146 includes: the surrounding situation detection unit 200 that generates surrounding situation data indicating the surrounding situation; and the determination unit 204 that determines whether or not the reception target data has been effectively used by the server 106, by comparing the evaluation index Z2 obtained when the transmission target data has been transmitted with the evaluation index Z1 obtained when the transmission target data has not been transmitted, in the learning period. Upon determining that the transmission target data has been effectively used, the determination unit 204 specifies, as transmission conditions, the traveling state data and the surrounding situation data obtained when the transmission target data has been transmitted. Thus, the server 106 can appropriately generate the evaluation index, and the in-vehicle device 100 can appropriately determine the transmission condition for uploading the data to the server 106.

### Operation (Upload) of Vehicle Inside-Outside Coordination Unit

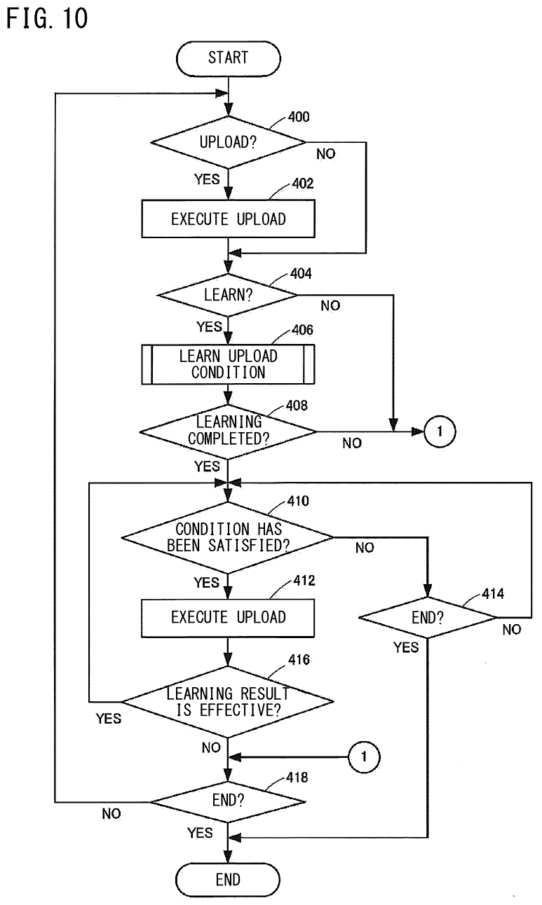

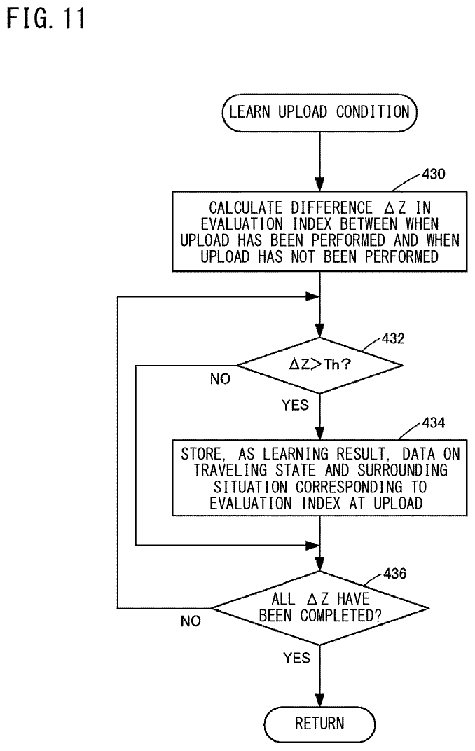

With reference to FIG. 10 and FIG. 11, the operation of the vehicle inside-outside coordination unit 122 related to upload will be described while referring to the functions shown in FIG. 9. The process shown in FIG. 10 is realized by the control unit 140 reading out a predetermined program from the memory 142, and executing the program. The process shown in FIG. 10 is started when, for example, the in-vehicle device 100 is powered on. It is assumed that a learning period T, an upload cycle ΔT1 and a learning cycle ΔT2 (e.g., ΔT2>ΔT1) during the learning period, a threshold value Th, etc., are stored in the memory 142 in advance. Upon receiving an evaluation index transmitted from the server 106, the control unit 140 executes, in parallel with the above program, a program for attaching a time stamp to the evaluation index and storing the evaluation index as evaluation result data 232. In the memory 142, sensor data 210 and upload data 230 are periodically stored with time stamps attached thereto. In addition, the surrounding situation detection unit 200 periodically executes the above process, and stores surrounding situation data 216 with a time stamp attached thereto.

In step 400, the control unit 140 determines whether or not to execute upload. Specifically, the control unit 140 determines whether or not a cycle ΔT1 has elapsed from when the previous upload was executed. When the determination result is that the cycle ΔT1 has elapsed, the control proceeds to step 402. Otherwise, the control proceeds to step 404. When step 400 is executed for the first time, the control unit 140 determines to execute upload. The control unit 140 may acquire the current time from, for example, a clock installed in the in-vehicle device 100.

In step 402, the control unit 140 controls the communication unit 120, and uploads the transmission target data (i.e., the upload data 230) to the server 106. Thereafter, the control proceeds to step 404.

In step 404, the control unit 140 determines whether or not to perform learning. Specifically, the control unit 140 determines whether or not a cycle ΔT2 has elapsed from when the previous learning was executed. When the determination result is that the cycle ΔT2 has elapsed, the control proceeds to step 406. Otherwise, the control proceeds to step 418. When step 404 is executed for the first time, the control unit 140 determines to execute learning. In step 406, the control unit 140 executes learning of the upload condition (i.e., transmission condition). Specifically, the control unit 140 executes the process shown in FIG. 11.

With reference to FIG. 11, in step 430, the control unit 140 reads out the evaluation result data 232 stored in the memory 142, and calculates a difference ΔZ (≥0) between the evaluation index Z2 obtained when the transmission target data has been uploaded and the evaluation index Z1 obtained when the transmission target data has not been uploaded, as described above. The evaluation index Z2 to be processed is one which has not been processed until then. The evaluation indices Z2 and Z1 used for calculating the difference are, for example, those to which times closest to each other are attached. If the number of the evaluation indices Z2 is less than the number of the evaluation indices Z1, calculation of the difference ΔZ may use: a representative value (e.g., average value) of evaluation indices Z1 positioned between every adjacent two evaluation indices Z2 when the indices are arranged in time series: and one of the adjacent two evaluation indices Z2. The control unit 140 attaches time information to the calculated difference ΔZ, and stores the difference ΔZ into the memory 142. As this time information, for example, the time information attached to the evaluation index Z2 used for calculating the difference may be used. Thereafter, the control proceeds to step 432.

In step 432, the control unit 140 determines whether or not the difference ΔZ calculated in step 430 is larger than the threshold value Th. If ΔZ>Th, the control proceeds to step 434. Otherwise, the control proceeds to step 436.

In step 434, the control unit 140 specifies the traveling state data and the surrounding situation data corresponding to the evaluation index Z2 (i.e., evaluation index at the time of upload) determined to be ΔZ>Th in step 432, and stores them as the learning result data 220. To specify the traveling state data and the surrounding situation data, the time information attached thereto may be compared with the time information attached to the corresponding evaluation index Z2. The control unit 140 specifies the traveling state data and the surrounding situation data to which time information that is the same as or close within a predetermined range to the time information attached to the evaluation index Z2, is attached.

In step 436, the control unit 140 determines whether or not step 432 has been executed for all the differences ΔZ calculated in step 430 previously executed. When the determination result is that step 432 has been executed for all the differences ΔZ, the control proceeds to step 408 in FIG. 10. Otherwise, the control returns to step 432.

Referring back to FIG. 10, in step 408, the control unit 140 determines whether or not the learning has been completed. Specifically, the control unit 140 determines whether or not the learning period T has elapsed. When the determination result is that the learning has been completed, the control proceeds to step 410. Otherwise, the control proceeds to step 418.

In step 410, the control unit 140 reads out the latest traveling state data 214 and surrounding situation data 216 from the memory 142, and determines whether or not the read data satisfy the upload condition (i.e., transmission condition). Specifically, the control unit 140 determines whether or not a set of traveling state data 214 and surrounding situation data 216, whose values are the same as or close within a predetermined range to the values of the read traveling state data 214 and surrounding situation data 216, is stored in the learning result data 220. When the determination result is that such a set is stored, the control proceeds to step 412. Otherwise, the control proceeds to step 414.

In step 412, the control unit 140 executes upload in the same manner as in step 402. Thereafter, the control proceeds to step 416.

When the determination result in step 410 is NO, in step 414, the control unit 140 determines whether or not an end instruction has been received. When the determination result is that an end instruction has been received, this program is ended. Otherwise, the control returns to step 410. The end instruction may be made by powering off the in-vehicle device 100.

In step 416, the control unit 140 determines whether or not the current learning result is effective. Specifically, the control unit 140 reads out, from the memory 142, the evaluation index Z2 (i.e., the latest evaluation result data 232) of the result that the transmission target data, uploaded in the just previously executed step 412, has been used by the server 106. Then, the control unit 140 calculates a difference ΔZ in the same manner as described above, and compares the difference ΔZ with the threshold value Th. As the evaluation index Z1 to be a reference when calculating the difference, a representative value (e.g., average value, median value, etc.) of the evaluation indices Z1 in the learning period may be used. If ΔZ>Th, the current learning result (i.e., the learning result data 220 stored in the memory 142) is determined to be effective, and the control returns to step 410. Otherwise, the control unit 140 deletes the learning result data 220 stored in the memory 142, and the control proceeds to step 418.

In step 418, as in step 414, the control unit 140 determines whether or not an end instruction has been received. When the determination result is that an end instruction has been received, this program is ended. Otherwise, the control returns to step 400.

### Operation (Upload) of Server

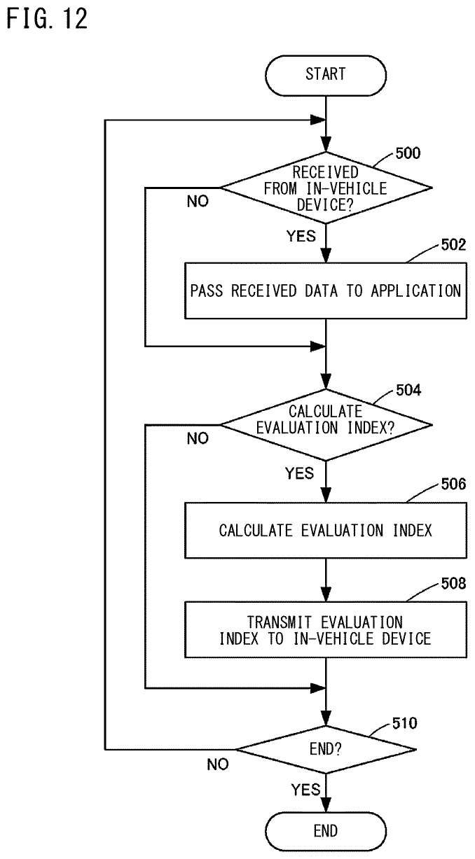

With reference to FIG. 12, the operation of the server 106 related to upload will be described with reference to the functions shown in FIG. 9. The process shown in FIG. 12 is realized by the control unit 160 shown in FIG. 4 reading out a predetermined program from the memory 162, and executing the program. The process shown in FIG. 12 is started, for example, when an application for providing a service (specifically, corresponding to the service execution unit 240) is executed. In parallel with this program, the control unit 160 executes the application providing the service, a program for detecting the surrounding situation of the vehicle by analyzing the sensor data received from the infrastructure sensor 114, etc. (corresponding to the surrounding situation detection unit 242), and the like.

In step 500, the control unit 160 determines whether or not data uploaded from the in-vehicle device has been received. When the determination result is that the uploaded data has been received, the control proceeds to step 502. Otherwise, the control proceeds to step 504.

In step 502, the control unit 160 passes the data received in step 500 to the application. Thereafter, the control proceeds to step 504. The application uses the received data for generation of service data. The server 106 receives data uploaded from a plurality of in-vehicle devices.

In step 504, the control unit 160 determines whether or not to calculate an evaluation index. For example, the evaluation index is periodically calculated. For example, the control unit 160 determines whether or not a predetermined period (e.g., cycle ΔT3) has elapsed from the previous calculation of the evaluation index. When the determination result is that the predetermined period has elapsed, the control proceeds to step 506. Otherwise, the control proceeds to step 510. When step 504 is executed for the first time, the control unit 160 determines to calculate the evaluation index.

In step 506, the control unit 160 calculates the evaluation index. This corresponds to the function of the evaluation unit 244 described above. Thereafter, the control proceeds to step 508.

In step 508, the control unit 160 attaches a time stamp to the evaluation index calculated in step 506, and broadcasts the evaluation index via the communication unit 164 (see FIG. 4). As described above, the vehicle inside-outside coordination unit 122 receives the transmitted evaluation index, and stores the evaluation index as the evaluation result data 232 into the memory 142. Thereafter, the control proceeds to step 510.

In step 510, the control unit 160 determines whether or not an end instruction has been received. When the determination result is that an end instruction has been received, this program is ended. Otherwise, the control returns to step 500. The end instruction is made when, for example, the administrator has operated an operation unit (e.g., a keyboard and a mouse) of the server 106 to end the application.

By repeating the processes in steps 400 to 408 in FIG. 10 and the processes in steps 500 to 508 in FIG. 12, upload and learning of the upload condition (transmission condition) are periodically executed until the learning is completed (until the learning period elapses). Although the upload and learning are periodically executed in the above description, the present disclosure is not limited thereto. The frequency of repeatedly executed upload just needs to be higher than the frequency of repeatedly executed learning. After completion of the learning, the processes in steps 410 to 416 in FIG. 10 and the processes in steps 500 to 508 in FIG. 12 are repeated, whereby whether or not to execute upload is determined by using the learning result, and upload is executed only when the upload condition is satisfied. Therefore, the frequency with which the in-vehicle device 100 uploads the data to the server 106 (i.e., roadside device, etc.) can be appropriately reduced without degrading the quality of the connected service, whereby useless upload can be inhibited.

When the learning result data 220 (see FIG. 9) stored in the memory 142 has become no longer effective (i.e., when there is no significant difference between the evaluation index Z2 and the evaluation index Z1 (specifically, when the determination result in step 416 is NO)), relearning is executed. That is, the control returns to step 400, and periodical upload and learning of the upload condition (i.e., transmission condition) are executed again. Thus, when the learning result has become no longer effective, relearning is quickly executed, and an appropriate transmission condition can be determined again.

As described above, the server 106 includes the service execution unit 240 that executes a predetermined service, the evaluation unit 244 that generates an evaluation index indicating the extent of effective use of the transmission target data by the service execution unit 240, and the communication unit 164 (see FIG. 4) that transmits the evaluation index to the in-vehicle device 100. Thus, the determination unit 204 can appropriately determine the transmission condition for uploading the data to the server 106, and the in-vehicle device 100 can appropriately reduce the frequency of uploading the data to the server 106, whereby useless upload can be inhibited.

In the above description, regarding the learning period related to upload, the cycle of upload during the learning period, the cycle of learning, and the threshold value, the same reference signs as those related to download are used. However, any numerical values may be practically used. The same value or different values may be used regarding download and upload. Further, learning may be completed not only when the learning period has elapsed, but also when a predetermined amount of learning result data have been collected.

The server may manage the transmission target data to be uploaded and the transmission source (i.e., in-vehicle device) in association with each other. In this case, if the evaluation index is broadcasted with information specifying the transmission source being attached thereto, each in-vehicle device can specify whether the received evaluation index is the evaluation index Z2 for which the data uploaded by the in-vehicle device has been considered, or the evaluation index Z1 other than the evaluation index Z2.

If vehicles (in-vehicle devices) having the same system configuration are used in the same traffic environment (e.g., urban area, depopulated area, etc.), these vehicles will have the same or similar learning result data. Therefore, the learning result data may be shared. For example, the result of learning (i.e., learning result data) obtained in a certain vehicle may be stored in a memory of an in-vehicle device of another vehicle, and propriety of download or upload may be determined in the other vehicle. If the learning result is “not appropriate”, the in-vehicle device of the other vehicle may execute relearning.

In the above description, the ECU that uses the downloaded data (i.e., reception target data) is the automated drive ECU, and the evaluation index depends on the traveling state of the vehicle and the surrounding situation of the vehicle. However, the present disclosure is not limited thereto. An appropriate evaluation index may be adopted according to the function of the ECU that uses the downloaded data. The information to be considered in generating the evaluation index is detected by the sensor 124, etc., and learning is performed by using a difference in evaluation index depending on whether or not the downloaded data is used, as described above, whereby the download condition (i.e., reception condition) can be determined. The same applies to learning of the upload condition.

### Modifications

In the above description, the in-vehicle device (specifically, the vehicle inside-outside coordination unit 122) learns the upload condition. However, the present disclosure is not limited thereto. The server may learn the upload condition of the in-vehicle device, and transmit the learning result to the in-vehicle device. The vehicle inside-outside coordination unit of the in-vehicle device does not perform learning related to upload, and determines propriety of upload by using the learning result received from the server.

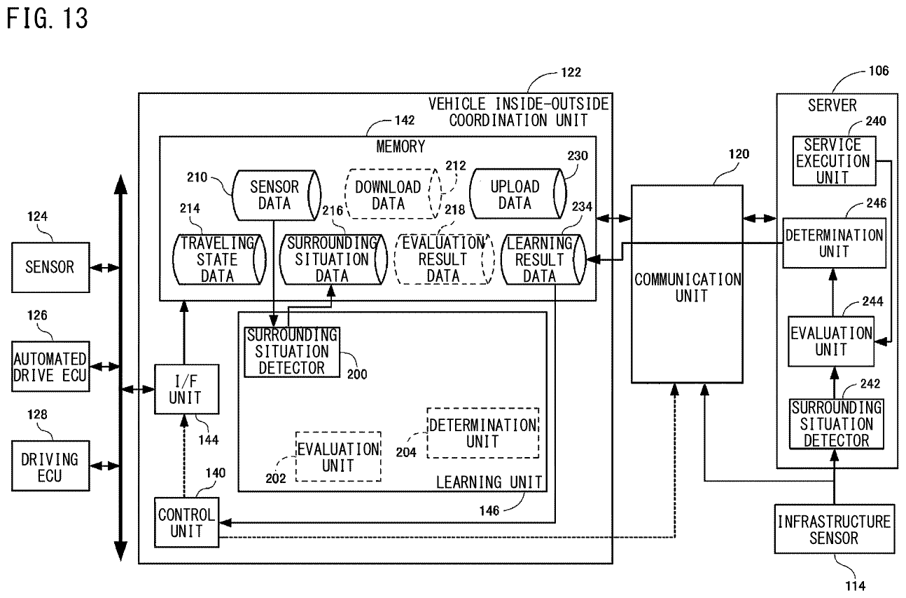

With reference to FIG. 13, the functions of the vehicle inside-outside coordination unit 122 and the server 106 according to the modification will be described. The vehicle inside-outside coordination unit 122 is configured as shown in FIG. 6. In FIG. 13, the vehicle inside-outside coordination unit 122 has the same components as those shown in FIG. 6, and components (i.e., the evaluation unit 202, determination unit 204, download data 212, and evaluation result data 218) not used for upload according to the modification are indicated by broken lines. As described above, an evaluation index indicating the extent of effective use of transmission target data (i.e., upload data) is used. Since the main device that calculates the evaluation index related to upload and performs learning is the server 106 as described later, the server 106 shown in FIG. 13 includes components necessary for that purpose. The “learning result data” stored in the memory 142 is received from the server 106 unlike the learning result data 220 shown in FIG. 6, and therefore is denoted by a reference sign “234” different from that in FIG. 6. In the following description, the same functions as the functions of the vehicle inside-outside coordination unit 122 and the server 106 when the vehicle inside-outside coordination unit 122 performs learning will not be repeatedly described, and different points will be mainly described.

The memory 142 has, stored therein, upload data 230 as that shown in FIG. 9, in addition to the pieces of data shown in FIG. 6. The upload data 230 is transmission target data to be uploaded, and is data (e.g., moving image data) to be effectively used by the server 106 among the sensor data 210 (i.e., output data of the sensor 124), for example.

The server 106 includes a service execution unit 240, a surrounding situation detection unit 242, an evaluation unit 244, and a determination unit 246 to deal with upload from the vehicle inside-outside coordination unit 122. Of these components, the service execution unit 240, the surrounding situation detection unit 242, and the evaluation unit 244 function in the same manner as those shown in FIG. 9. That is, the service execution unit 240 executes connected services (e.g., provision of driving support information, remote monitoring, remote control, etc.) provided by the server 106. The surrounding situation detection unit 242 detects the surrounding situation of a vehicle (i.e., vehicle 102) corresponding to the uploaded transmission target data, from the sensor data received from the infrastructure sensor 114, and outputs the detection result to the evaluation unit 244. The evaluation unit 244 generates an evaluation index by evaluating the output data (i.e., service data) of the service execution unit 240.

The determination unit 246 acquires evaluation indices Z1 and Z2 from the evaluation unit 244, and determines whether or not there is a significant difference between Z1 and Z2, like the determination unit 204 of the vehicle inside-outside coordination unit 122 shown in FIG. 6. The determination unit 246 calculates a difference ΔZ between Z1 and Z2, and determines whether or not the difference ΔZ is larger than a predetermined threshold value Th. If ΔZ>Th, traveling state data and surrounding situation data of the vehicle corresponding to Z2 are read out from the memory 162 (see FIG. 4), and are transmitted to the vehicle 102 (specifically, the vehicle inside-outside coordination unit 122). A time stamp may be used to specify the data corresponding to Z2 from the traveling state data and the surrounding situation data stored in the memory 162.

For example, as shown in FIG. 10, the vehicle inside-outside coordination unit 122 repeatedly (e.g., periodically) performs upload. The server 106 repeatedly (e.g., periodically) calculates the evaluation index as described above, performs learning by using the evaluation index, and transmits the learning result to the vehicle inside-outside coordination unit 122, during a predetermined period (learning period). Thus, learning result data 234 is accumulated. After the learning period has elapsed, the vehicle inside-outside coordination unit 122 determines propriety of upload, with the learning result data 234 being the transmission condition. That is, the control unit 140 in the vehicle inside-outside coordination unit 122 reads out the latest traveling state data 214 and surrounding situation data 216 from the memory 142, and determines whether or not the read data satisfy the learning result data 234 (i.e., transmission condition). Specifically, the control unit 140 determines whether or not a set of traveling state data 214 and surrounding situation data 216, whose values are the same as or close within a predetermined range to the values of the read traveling state data 214 and surrounding situation data 216, is stored in the learning result data 234. When the determination result is that such a set is stored, upload is executed. Otherwise, upload is not executed. Thus, the in-vehicle device 100 (specifically, the vehicle inside-outside coordination unit 122) having received the transmission condition can appropriately reduce the frequency with which the in-vehicle device 100 uploads the data to the server 106 (i.e., roadside device, etc.), thereby inhibiting useless upload.

Also, in this modification, it is preferred to perform relearning when the learning result has become no longer appropriate. For this purpose, as in the configuration shown in FIG. 9, the evaluation index may be transmitted from the evaluation unit 244 to the in-vehicle device 100, and stored in the memory 142 (i.e., the evaluation result data 218). For example, after determining propriety of upload by using the learning result data 234 (i.e., the learning result by the server 106), the control unit 140 in the vehicle inside-outside coordination unit 122 determines whether or not the current learning result is effective, with reference to the evaluation result data 218, as in step 416 shown in FIG. 10. If the determination result is that the current learning result is not effective, the vehicle inside-outside coordination unit 122 deletes the current learning result data 234, transmits a request for relearning to the server 106, and thereafter, repeatedly (e.g., periodically) executes upload during a predetermined period (i.e., learning period). Upon receiving the request for relearning, the server 106 (specifically, the determination unit 246) again executes learning as described above, and transmits the learning result to the vehicle inside-outside coordination unit 122. Thus, when the learning result has become no longer effective, the vehicle inside-outside coordination unit 122 can cause the server 106 to quickly execute relearning, whereby an appropriate transmission condition can be determined again.

In the above description, the reception condition and the transmission condition are individually collected (i.e., learned) to generate the learning result data shown in FIG. 6, FIG. 9, and FIG. 13. However, the present disclosure is not limited thereto. Machine learning may be performed to determine whether or not the situation is suitable for reception and transmission (hereinafter referred to as “propriety of reception and transmission”). For example, learning may be performed using a neural network. In this case, learning data and a model (i.e., neural network) are prepared. The model that judges propriety of reception (i.e., download) is, for example, included in the vehicle inside-outside coordination unit 122, as a program that substitutes for the learning result data 220 in FIG. 6, for example. The traveling state (e.g., position, speed, etc.) of the vehicle and the surrounding situation (e.g., traffic jam, traffic accident, blind spot, etc.) of the vehicle are used as input data to an input layer of the model, and output data from an output layer of the model is used as data indicating presence or absence of download. Then, it is conceivable to cause the model to learn by using these learning data. Regarding quantification of presence or absence of download, “1” may be set when download is performed, and “0” may be set when download is not performed. The number of neurons in the output layer may be one. Regarding quantification of the speed as input data, the speed value itself (or a normalized value thereof (i.e., a value obtained by multiplying the speed itself by a constant to make the magnitudes of the input values uniform)) may be used. Regarding quantification of the surrounding environment of the vehicle, for a traffic jam, for example, the number of vehicles around the own vehicle (e.g., within a predetermined area) may be used, and for a traffic accident, “1” may be set if an accident has occurred around the own vehicle (e.g., within a predetermined range), and “0” may be set if no accident has occurred. A blind spot may be quantified by using the angle, the size (i.e., area) of the blind spot, etc. (or a normalized value thereof). These values can be acquired by, for example, analyzing the moving image data obtained by the sensor of the own vehicle. In learning, a sigmoid function or the like is used as an activation function for synapses in an intermediate layer, and the activation function for the synapses in the intermediate layer may be adjusted by using the above-described learning data (corresponding to teacher data) so as to minimize a loss function. Likewise, also in the case of upload, it is conceivable to perform learning by using the output of the output layer as presence or absence of upload. Regarding quantification of presence or absence of upload, “1” may be set when upload is performed, and “0” may be set when upload is not performed.

As described above, during the predetermined period, the learning unit 146 repeatedly (e.g., periodically) executes download, and compares the difference ΔZ in evaluation index with the threshold value Th to determine propriety (“1” or “0”) of download. The determination result, and the traveling state (e.g., position, speed, etc.) of the corresponding vehicle and the surrounding situation of the vehicle (e.g., traffic jam, accident, blind spot, etc.) may be collected as learning data. For example, the control unit 140 causes the model to learn as described above, by using the collected learning data. The model after learning outputs data indicating presence or absence (i.e., propriety) of download when the traveling state and the surrounding situation of the vehicle are inputted thereto. Therefore, the control unit 140 reads out the latest traveling state and surrounding situation of the vehicle from the memory 142, and inputs them to the model after learning. The control unit 140 executes download if the output value from the model after learning is “1”, and does not execute download if the output value is “0”. This makes it possible to automatically determine propriety of download without the necessity of collecting and storing the download condition (i.e., reception condition) as shown in FIG. 6 and FIG. 7. Therefore, the vehicle inside-outside coordination unit 122 executes download when there is a high possibility that the reception target data (i.e., data, such as driving support information, of the connected service provided by the server 106) is effectively used. Otherwise, the vehicle inside-outside coordination unit 122 does not execute download. That is, the frequency with which the in-vehicle device 100 downloads the data of the service provided from the server 106 (i.e., roadside device, etc.) can be appropriately reduced without degrading the quality of the connected service, whereby useless download can be inhibited.

Likewise, regarding upload, during the predetermined period, the learning unit 146 repeatedly (e.g., periodically) executes upload, and compares the difference ΔZ in evaluation index with the threshold value Th to determine propriety (“1” or “0”) of upload. The determination result, and the traveling state of the corresponding vehicle and the surrounding situation of the vehicle are collected as learning data. The model is caused to learn by using the collected learning data. The model for determining propriety of transmission (i.e., upload) is included in the vehicle inside-outside coordination unit 122, as a program that substitutes for the learning result data 220 in FIG. 9, for example. The model after learning outputs data indicating presence or absence (i.e., propriety) of upload when the traveling state and surrounding situation of the vehicle are inputted thereto. Therefore, the control unit 140 reads out the latest traveling state and surrounding situation of the vehicle from the memory 142, and inputs them to the model after learning. The control unit 140 executes upload if the output value from the model after learning is “1”, and does not execute upload if the output value is “0”.

This makes it possible to automatically determine propriety of upload without the necessity of collecting and storing the upload condition (i.e., transmission condition) as shown in FIG. 9 and FIG. 10. Therefore, the vehicle inside-outside coordination unit 122 executes upload when there is a high possibility that the transmission target data (i.e., data, such as sensor data, of the connected service provided by the server 106) is effectively used. Otherwise, the vehicle inside-outside coordination unit 122 does not execute upload. That is, the frequency with which the in-vehicle device 100 uploads the data to the server 106 (i.e., roadside device, etc.) can be appropriately reduced without degrading the quality of the connected service, whereby useless upload can be inhibited.

Furthermore, learning regarding download and learning regarding upload may be collectively performed. In this case, since the output of the model needs to represent three cases, i.e., “executing download”, “executing upload”, and “executing none of them”, three neurons are used in the output layer of the model. A Softmax function may be used as the activation function for synapses in the output layer, and a sigmoid function or the like may be used as the activation function for synapses in the intermediate layer. When the activation function for the synapses in the intermediate layer is adjusted by using the learning data so as to minimize the loss function, the outputs from the synapses in the output layer represent the probabilities of the corresponding three types. Therefore, by selecting one corresponding to the maximum value, any of the three types (i.e., “executing download”, “executing upload”, and “executing none of them”) is determined.

In the modification (see FIG. 13), after the model (specifically, program) is prepared in the server 106 and machine learning is executed as described above, the vehicle inside-outside coordination unit 122 may receive the model after learning from the server 106 and use the model instead of the learning result data 234. Alternatively, a model of the same configuration as the model in the server 106 may be prepared in the vehicle inside-outside coordination unit 122 in advance, and parameters of the model after learning in the server 106 (i.e., parameters specifying the activation function) may be received from the server 106 and applied to the model in the vehicle inside-outside coordination unit 122.

Reinforcement learning may be executed during a predetermined period without using the teacher data. In addition, machine learning such as support vector machine may be performed, without using the neural network. When determining a download condition or an upload condition, this determination comes down to classifying a set (i.e., multidimensional data) of features (e.g., the traveling state and the surrounding situation of the vehicle) into two types (i.e., executing download (upload), and not executing download (upload)) by using the support vector machine. When determining one of three types, i.e., “executing download”, “executing upload”, and “executing none of them”, this determination comes down to classifying the set (i.e., multidimensional data) of the features (e.g., the traveling state and the surrounding situation of the vehicle) into the three types by using the support vector machine.

The processes (functions) of the above-described embodiment may be realized by processing circuitry including one or more processors. In addition to the one or more processors, the processing circuitry may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU, a GPU (Graphics Processing Unit), a DSP (Digital Signal Processor), an FPGA (Field Programmable Gate Array), an ASIC (Application Specific Integrated Circuit), etc., which are compatible with computer control.

Furthermore it is possible to provide a recording medium in which a program for causing a computer to execute the processes of the in-vehicle device 100, specifically, the processes that the vehicle inside-outside coordination unit 122 executes (e.g., the processes shown in FIG. 7, FIG. 8, FIG. 10, and FIG. 11), is recorded. The recording medium is, for example, an optical disc (DVD (Digital Versatile Disc), etc.), or a detachable semiconductor memory (USB (Universal Serial Bus) memory, etc.). The computer program can be transmitted via a communication line, and the recording medium means a non-transitory recording medium. By causing the computer mounted in the vehicle to read the program stored in the recording medium, the computer, when the in-vehicle device uploads data to an external device such as a roadside device, can transmit data to be effectively used by a service provided by the external device while considering a delay time and a communication band.

### Additional Note 1

A computer-readable non-transitory recording medium having, stored therein, a computer program,
the computer program causing a computer installed in a vehicle to realize:

a communication function of receiving reception target data from a roadside device that is a device located outside the vehicle: and
a learning function of learning a reception condition for the reception target data by evaluating an extent to which the reception target data received by the communication function has been used by a function control device installed in the vehicle, wherein
the learning function includes a function of specifying the reception condition, during a learning period in which the reception target data is repeatedly received by the communication function, and
the communication function includes a function of receiving the reception target data according to whether or not the reception condition is satisfied, after the reception condition has been specified by the learning function.

### Additional Note 2

A computer-readable non-transitory recording medium having, stored therein, a computer program,
the computer program causing a computer installed in a vehicle to realize:

a communication function of receiving reception target data from a roadside device that is a device located outside the vehicle; and
a learning function of learning propriety of reception of the reception target data by the communication function, wherein
the learning function includes
   an acquisition function of acquiring output data of a function control device installed in the vehicle, and traveling state data indicating a traveling state of the vehicle,
   a surrounding situation detection function of generating surrounding situation data indicating a surrounding situation of the vehicle,
   an evaluation function of generating an evaluation index that evaluates traveling of the vehicle from the output data, during a predetermined period in which the reception target data is repeatedly received by the communication function,
   a determination function of determining whether or not the reception target data has been effectively used by the function control device, by comparing the evaluation index obtained when the reception target data has been received with the evaluation index obtained when the reception target data has not been received, during the predetermined period, and
   a function of causing a model to perform machine learning by using learning data, the model outputting data indicating propriety of reception according to input data including the traveling state data and the surrounding situation data,
the communication function includes a function of receiving the reception target data according to the output data of the model after learning, and
the learning data includes, as the input data, the traveling state data and the surrounding situation data that have been collected during the predetermined period, and includes, as the output data of the model, results of determination by the determination function that have been collected during the predetermined period.

### Additional Note 3

A computer-readable non-transitory recording medium having, stored therein, a computer program,
the computer program causing a computer installed in a vehicle to realize:
a communication function of transmitting transmission target data to a roadside device that is a device located outside the vehicle, and receiving, from the roadside device, an evaluation index indicating an extent to which the transmission target data has been used by the roadside device: and
a learning function of learning a transmission condition for the transmission target data according to the evaluation index, wherein
the learning function includes a function of specifying the transmission condition, during a learning period in which the transmission target data is repeatedly transmitted by the communication function, and
the communication function includes a function of transmitting the transmission target data according to whether or not the transmission condition is satisfied, after the transmission condition has been specified by the learning function.

### Additional Note 4

A computer-readable non-transitory recording medium having, stored therein, a computer program,
the computer program causing a computer installed in a vehicle to realize:
a communication function of transmitting transmission target data to a roadside device that is a device located outside the vehicle, and receiving, from the roadside device, an evaluation index that evaluates a service provided by the roadside device; and
a learning function of learning propriety of transmission of the transmission target data by the communication function, wherein
the communication function includes a function of transmitting, to the roadside device, traveling state data indicating a traveling state of the vehicle,
the evaluation index is generated by the roadside device, with the traveling state data and a surrounding situation of the vehicle being considered,
the learning function includes
   a surrounding situation detection function of generating surrounding situation data indicating the surrounding situation,
   a determination function of determining whether or not the transmission target data has been effectively used by the roadside device, by comparing the evaluation index obtained when the transmission target data has been transmitted with the evaluation index obtained when the transmission target data has not been transmitted, during a predetermined period in which the transmission target data is repeatedly transmitted by the communication function, and
   a function of causing a model to perform machine learning by using learning data, the model outputting data indicating the propriety of transmission according to input data including the traveling state data and the surrounding situation data,
the communication function further includes a function of transmitting the transmission target data according to output data of the model after learning, and
the learning data includes, as the input data, the traveling state data and the surrounding situation data that have been collected during the predetermined period, and includes, as the output data of the model, results of determination by the determination function that have been collected during the predetermined period.

While the present disclosure has been described through description of an embodiment above, the above embodiment is merely illustrative and the present disclosure is not limited to only the above embodiment. The scope of the present disclosure is defined by each claim of the scope of claims with reference to the above description, and includes meanings equivalent to the wordings described therein and all modifications within the scope of claims.

### REFERENCE SIGNS LIST

100, 110 in-vehicle device
102, 112 vehicle
104 base station
106 server
108 network
114 infrastructure sensor
120, 164 communication unit
122 vehicle inside-outside coordination unit
124 sensor
126 automated drive ECU
128 driving ECU
130, 166 bus
140, 160 control unit
142, 162 memory
144 I/F unit
146 learning unit
200, 242 surrounding situation detection unit
202, 244 evaluation unit
204, 246 determination unit
210 sensor data
212 download data
214 traveling state data
216 surrounding situation data
218, 232 evaluation result data
220, 234 learning result data
230 upload data
240 service execution unit
300, 302, 304, 306, 308, 310, 312, 314, 316, 318, 330, 332, 334, 336, 400, 402, 404, 406, 408, 410, 412, 414, 416, 418, 430, 432, 434, 436, 500, 502, 504, 506, 508, 510 step

1. An in-vehicle device installed in a vehicle, comprising:
a communication unit configured to receive reception target data from a roadside device that is a device located outside the vehicle; and
a learning unit configured to learn a reception condition for the reception target data by evaluating an extent to which the reception target data received by the communication unit has been used by a function control device installed in the vehicle, wherein
the learning unit specifies the reception condition, during a learning period in which the communication unit repeatedly receives the reception target data, and
the communication unit receives the reception target data according to whether or not the reception condition is satisfied, after the reception condition has been specified by the learning unit.

2. The in-vehicle device according to claim 1, wherein the learning unit includes:
an acquisition unit configured to acquire output data of the function control device, and traveling state data indicating a traveling state of the vehicle;
a surrounding situation detection unit configured to generate surrounding situation data indicating a surrounding situation of the vehicle;
an evaluation unit configured to generate a first evaluation index that evaluates traveling of the vehicle from the output data; and
a determination unit configured to determine whether or not the reception target data has been effectively used by the function control device, by comparing the first evaluation index obtained when the reception target data has been received with the first evaluation index obtained when the reception target data has not been received, during the learning period, and
upon determining that the reception target data has been effectively used, the determination unit specifies, as the reception condition, the traveling state data and the surrounding situation data obtained when the reception target data has been received.

3. The in-vehicle device according to claim 2, wherein
the first evaluation index includes at least one of comfort, traffic efficiency, and safety related to traveling of the vehicle.

4. The in-vehicle device according to claim 2, wherein
the determination unit determines whether or not the reception target data has been effectively used by the function control device, by determining whether or not a difference of the first evaluation index obtained when the reception target data has been received, with respect to the first evaluation index obtained when the reception target data has not been received, during the learning period, is larger than or equal to a predetermined value that is larger than 0, and
after the reception condition has been specified by the learning unit, if the difference becomes smaller than the predetermined value, the learning unit causes the communication unit to repeatedly receive the reception target data, and again executes a process of specifying the reception condition.

5. The in-vehicle device according to claim 1, wherein
with the function control device having been updated, the learning unit causes the communication unit to repeatedly receive the reception target data, and again executes the process of specifying the reception condition.

6. The in-vehicle device according to claim 1, wherein
the communication unit further
transmits transmission target data to the roadside device, and
receives, from the roadside device, a second evaluation index that evaluates a service provided by the roadside device,
the learning unit further
learns a transmission condition for the transmission target data according to the second evaluation index, and
specifies the transmission condition, during a period in which the communication unit repeatedly transmits the transmission target data, and
after the transmission condition has been specified by the learning unit, the communication unit transmits the transmission target data depending on whether or not the transmission condition is satisfied.

7. An in-vehicle device installed in a vehicle, comprising:
a communication unit configured to receive reception target data from a roadside device that is a device located outside the vehicle; and
a learning unit configured to learn propriety of reception of the reception target data by the communication unit, wherein
the learning unit includes
an acquisition unit configured to acquire output data of a function control device installed in the vehicle, and traveling state data indicating a traveling state of the vehicle,
a surrounding situation detection unit configured to generate surrounding situation data indicating a surrounding situation of the vehicle,
an evaluation unit configured to generate an evaluation index that evaluates traveling of the vehicle from the output data, during a predetermined period in which the communication unit repeatedly receives the reception target data,
a determination unit configured to determine whether or not the reception target data has been effectively used by the function control device, by comparing the evaluation index obtained when the reception target data has been received with the evaluation index obtained when the reception target data has not been received, during the predetermined period, and
a model configured to output data indicating the propriety of reception according to input data including the traveling state data and the surrounding situation data,
the learning unit causes the model to perform machine learning by using learning data,
the communication unit receives the reception target data according to output data of the model after learning, and
the learning data includes, as the input data, the traveling state data and the surrounding situation data that have been collected during the predetermined period, and includes, as the output data of the model, results of determination by the determination unit that have been collected during the predetermined period.

8. An in-vehicle device installed in a vehicle, comprising:
a communication unit configured to transmit transmission target data to a roadside device that is a device located outside the vehicle, and receive, from the roadside device, an evaluation index that evaluates a service provided by the roadside device; and
a learning unit configured to learn a transmission condition for the transmission target data by using the evaluation index, wherein
the learning unit specifies the transmission condition, during a learning period in which the communication unit repeatedly transmits the transmission target data, and
the communication unit transmits the transmission target data according to whether or not the transmission condition is satisfied, after the transmission condition has been specified by the learning unit.

9. The in-vehicle device according to claim 8, wherein
the communication unit further transmits, to the roadside device, traveling state data indicating a traveling state of the vehicle,
the evaluation index is generated by the roadside device, with the traveling state data and a surrounding situation of the vehicle being considered,
the learning unit includes
a surrounding situation detection unit configured to generate surrounding situation data indicating the surrounding situation, and
a determination unit configured to determine whether or not the transmission target data has been effectively used by the roadside device, by comparing the evaluation index obtained when the transmission target data has been transmitted with the evaluation index obtained when the transmission target data has not been transmitted, during the learning period, and
upon determining that the transmission target data has been effectively used, the determination unit specifies, as the transmission condition, the traveling state data and the surrounding situation data obtained when the transmission target data has been transmitted.

10. The in-vehicle device according to claim 9, wherein
the determination unit determines whether or not the transmission target data has been effectively used by the roadside device, by determining whether or not a difference of the evaluation index obtained when the transmission target data has been transmitted with respect to the evaluation index obtained when the transmission target data has not been transmitted, during the learning period, is larger than or equal to a predetermined value larger than 0, and
after the transmission condition has been specified by the learning unit, if the difference becomes smaller than the predetermined value, the learning unit causes the communication unit to repeatedly transmit the transmission target data, and again executes a process of specifying the transmission condition.

11. An in-vehicle device installed in a vehicle, comprising:
a communication unit configured to transmit transmission target data to a roadside device that is a device located outside the vehicle, and receive, from the roadside device, an evaluation index that evaluates a service provided by the roadside device; and
a learning unit configured to learn propriety of transmission of the transmission target data by the communication unit, wherein
the communication unit further transmits, to the roadside device, traveling state data indicating a traveling state of the vehicle,
the evaluation index is generated by the roadside device with the traveling state data and a surrounding situation of the vehicle being considered,
the learning unit includes
a surrounding situation detection unit configured to generate surrounding situation data indicating the surrounding situation,
a determination unit configured to determine whether or not the transmission target data has been effectively used by the roadside device, by comparing the evaluation index obtained when the transmission target data has been transmitted with the evaluation index obtained when the transmission target data has not been transmitted, during a predetermined period in which the communication unit repeatedly transmits the transmission target data, and
a model configured to output data indicating the propriety of transmission according to input data including the traveling state data and the surrounding situation data,
the learning unit causes the model to perform machine learning by using learning data,
the communication unit transmits the transmission target data according to output data of the model after learning, and
the learning data includes, as the input data, the traveling state data and the surrounding situation data that have been collected during the predetermined period, and includes, as the output data of the model, results of determination by the determination unit that have been collected during the predetermined period.

12. A roadside device that communicates with the in-vehicle device according to claim 8, and receives the transmission target data,
the roadside device comprising:
a service execution unit configured to execute a predetermined service;
an evaluation unit configured to generate an evaluation index indicating an extent to which the transmission target data has been used by the service execution unit, and
a communication unit configured to transmit the evaluation index to the in-vehicle device.

13. A roadside device comprising:
a communication unit configured to communicate with an in-vehicle device installed in a vehicle, and receive transmission target data;
a service execution unit configured to execute a predetermined service; and
a learning unit configured to learn a transmission condition for the transmission target data by the in-vehicle device, by evaluating an extent to which the transmission target data received by the communication unit has been used by the service execution unit, wherein
the learning unit specifies the transmission condition, during a learning period in which the communication unit receives the transmission target data that is repeatedly transmitted, and
the communication unit transmits the transmission condition specified by the learning unit to the in-vehicle device.

14. A control method for an in-vehicle device installed in a vehicle, the method comprising:
a communication step of receiving reception target data from a roadside device that is a device located outside the vehicle; and
a learning step of learning a reception condition for the reception target data by evaluating an extent to which the reception target data received by the communication unit has been used by a function control device installed in the vehicle, wherein
the learning step includes specifying the reception condition, during a learning period in which the reception target data is repeatedly received in the communication step, and
the communication step includes receiving the reception target data according to whether or not the reception condition is satisfied, after the reception condition has been specified in the learning step.

15. A control method for an in-vehicle device installed in a vehicle, the method comprising:
a communication step of receiving reception target data from a roadside device that is a device located outside the vehicle; and
a learning step of learning propriety of reception of the reception target data in the communication step, wherein
the learning step includes
an acquisition step of acquiring output data of a function control device installed in the vehicle, and traveling state data indicating a traveling state of the vehicle,
a surrounding situation detection step of generating surrounding situation data indicating a surrounding situation of the vehicle,
an evaluation step of generating an evaluation index that evaluates traveling of the vehicle from the output data, during a predetermined period in which the reception target data is repeatedly received in the communication step,
a determination step of determining whether or not the reception target data has been effectively used by the function control device, by comparing the evaluation index obtained when the reception target data has been received with the evaluation index obtained when the reception target data has not been received, during the predetermined period, and
a step of causing a model to perform machine learning by using learning data, the model outputting data indicating the propriety of reception according to input data including the traveling state data and the surrounding situation data,
the communication step includes receiving the reception target data according to output data of the model after learning, and
the learning data includes, as the input data, the traveling state data and the surrounding situation data that have been collected during the predetermined period, and includes, as the output data of the model, results of determination in the determination step that have been collected during the predetermined period.

16. A control method for an in-vehicle device installed in a vehicle, the method comprising:
a communication step of transmitting transmission target data to a roadside device that is a device located outside the vehicle, and receiving, from the roadside device, an evaluation index indicating an extent to which the transmission target data has been used by the roadside device; and
a learning step of learning a transmission condition for the transmission target data by using the evaluation index, wherein
the learning step includes specifying the transmission condition, during a learning period in which the transmission target data is repeatedly transmitted in the communication step, and
the communication step includes transmitting the transmission target data according to whether or not the transmission condition is satisfied, after the transmission condition has been specified in the learning step.

17. A control method for an in-vehicle device installed in a vehicle, the method comprising:
a communication step of transmitting transmission target data to a roadside device that is a device located outside the vehicle, and receiving, from the roadside device, an evaluation index that evaluates a service provided by the roadside device; and
a learning step of learning propriety of transmission of the transmission target data in the communication step, wherein
the communication step includes transmitting, to the roadside device, traveling state data indicating a traveling state of the vehicle,
the evaluation index is generated by the roadside device with the traveling state data and a surrounding situation of the vehicle being considered,
the learning step includes
a surrounding situation detection step of generating surrounding situation data indicating the surrounding situation,
a determination step of determining whether or not the transmission target data has been effectively used by the roadside device, by comparing the evaluation index obtained when the transmission target data has been transmitted with the evaluation index obtained when the transmission target data has not been transmitted, during a predetermined period in which the transmission target data is repeatedly transmitted in the communication step, and
a step of causing a model to perform machine learning by using learning data, the model outputting data indicating the propriety of transmission according to input data including the traveling state data and the surrounding situation data,
the communication step further includes transmitting the transmission target data according to output data of the model after learning, and
the learning data includes, as the input data, the traveling state data and the surrounding situation data that have been collected during the predetermined period, and includes, as the output data of the model, results of determination in the determination step that have been collected during the predetermined period.

18. A computer-readable non-transitory recording medium having, stored therein, a computer program,
the computer program causing a computer installed in a vehicle to realize:
a communication function of receiving reception target data from a roadside device that is a device located outside the vehicle; and
a learning function of learning a reception condition for the reception target data by evaluating an extent to which the reception target data received by the communication function has been used by a function control device installed in the vehicle, wherein
the learning function includes a function of specifying the reception condition, during a learning period in which the reception target data is repeatedly received by the communication function, and
the communication function includes a function of receiving the reception target data according to whether or not the reception condition is satisfied, after the reception condition has been specified by the learning function.

19. A computer-readable non-transitory recording medium having, stored therein, a computer program,
the computer program causing a computer installed in a vehicle to realize:
a communication function of receiving reception target data from a roadside device that is a device located outside the vehicle; and
a learning function of learning propriety of reception of the reception target data by the communication function, wherein
the learning function includes
an acquisition function of acquiring output data of a function control device installed in the vehicle, and traveling state data indicating a traveling state of the vehicle,
a surrounding situation detection function of generating surrounding situation data indicating a surrounding situation of the vehicle,
an evaluation function of generating an evaluation index that evaluates traveling of the vehicle from the output data, during a predetermined period in which the reception target data is repeatedly received by the communication function,
a determination function of determining whether or not the reception target data has been effectively used by the function control device, by comparing the evaluation index obtained when the reception target data has been received with the evaluation index obtained when the reception target data has not been received, during the predetermined period, and
a function of causing a model to perform machine learning by using learning data, the model outputting data indicating propriety of reception according to input data including the traveling state data and the surrounding situation data,
the communication function includes a function of receiving the reception target data according to output data of the model after learning, and
the learning data includes, as the input data, the traveling state data and the surrounding situation data that have been collected during the predetermined period, and includes, as the output data of the model, results of determination by the determination function that have been collected during the predetermined period.

20. A computer-readable non-transitory recording medium having, stored therein, a computer program,
the computer program causing a computer installed in a vehicle to realize:
a communication function of transmitting transmission target data to a roadside device that is a device located outside the vehicle, and receiving, from the roadside device, an evaluation index indicating an extent to which the transmission target data has been used by the roadside device; and
a learning function of learning a transmission condition for the transmission target data according to the evaluation index, wherein
the learning function includes a function of specifying the transmission condition, during a learning period in which the transmission target data is repeatedly transmitted by the communication function, and
the communication function includes a function of transmitting the transmission target data according to whether or not the transmission condition is satisfied, after the transmission condition has been specified by the learning function.

21. A computer-readable non-transitory recording medium having, stored therein, a computer program,
the computer program causing a computer installed in a vehicle to realize:
a communication function of transmitting transmission target data to a roadside device that is a device located outside the vehicle, and receiving, from the roadside device, an evaluation index that evaluates a service provided by the roadside device; and
a learning function of learning propriety of transmission of the transmission target data by the communication function, wherein
the communication function includes a function of transmitting, to the roadside device, traveling state data indicating a traveling state of the vehicle,
the evaluation index is generated by the roadside device, with the traveling state data and a surrounding situation of the vehicle being considered,
the learning function includes
a surrounding situation detection function of generating surrounding situation data indicating the surrounding situation,
a determination function of determining whether or not the transmission target data has been effectively used by the roadside device, by comparing the evaluation index obtained when the transmission target data has been transmitted with the evaluation index obtained when the transmission target data has not been transmitted, during a predetermined period in which the transmission target data is repeatedly transmitted by the communication function, and
a function of causing a model to perform machine learning by using learning data, the model outputting data indicating the propriety of transmission according to input data including the traveling state data and the surrounding situation data,
the communication function further includes a function of transmitting the transmission target data according to output data of the model after learning, and
the learning data includes, as the input data, the traveling state data and the surrounding situation data that have been collected during the predetermined period, and includes, as the output data of the model, results of determination by the determination function that have been collected during the predetermined period.
